(19) United States
(12) Patent Application Publication
(10) Pub. No.: US 2026/0070187 A1
(43) Pub. Date: Mar. 12, 2026

(54) POLISHING TOOL HOLDER, POLISHING TOOL, AND POLISHING SYSTEM

(71) Applicant: XEBEC TECHNOLOGY CO., LTD., Tokyo (JP)

(72) Inventors: Keisuke FUKUSHIMA, Tokyo (JP); Yoshiteru KAGEYAMA, Tokyo (JP)

(21) Appl. No.: 18/997,795

(22) PCT Filed: Jul. 25, 2022
(86) PCT No.: PCT/JP2022/028582

§ 371 Date: Nov. 26, 2025

(51) Int. Cl. B24B 49/10; B24B 29/00; B24B 41/04

(52) U.S. Cl. CPC B24B 49/10; B24B 29/005; B24B 41/04

(57) ABSTRACT

A polishing device (1) stores and retains a reference dimension (M) which is an initial dimension of linear grinding members (2), a polishing operation count, and a wear pattern (P) in which a wear amount of being worn by a single polishing operation is associated with the polishing operation count, in a storage unit (52) of a polishing tool holder (4). When a rotation detector (53) detects a rotation state, a control unit (51) of the polishing tool holder (4) updates the polishing operation count by adding 1 to the polishing operation count and acquires the wear amount by referring to the wear pattern (P) based on the updated polishing operation count. When termination of the rotation state is detected, the control unit (51) performs a grinding member protruding operation that drives a motor and operates a moving mechanism (22) to move the polishing brush (3) in an axial direction by a distance corresponding to the wear amount.

### FIELD

The present invention relates to a polishing tool holder that removably holds a polishing tool such as a polishing brush. The present invention also relates to a polishing device including a polishing tool and a polishing tool holder. The present invention further relates to a polishing system including a polishing device and a cloud computer connected to the polishing device via a network.

### BACKGROUND

A polishing tool holder that removably holds a polishing brush is described in Patent Literature 1. In this literature, the polishing tool holder has a shank, a sleeve positioned forward of the shank in an axial direction of the shank, and a shaft extending inside the sleeve coaxially with the shank. The shaft is rotatable relative to the shank and the sleeve about an axis of the shank. The polishing tool holder has a bolt portion provided in the shaft inside the sleeve and a nut screwed onto the bolt portion. The polishing tool is a polishing brush and includes a plurality of linear grinding members arranged in parallel with their length direction aligned with the axial direction of the shank, and a grinding member holder that holds one end in the axial direction of each of the linear grinding members. The polishing tool has the grinding member holder connected to the nut and is held in the polishing tool holder. When the polishing tool is held in the polishing tool holder, the other ends of the linear grinding members protrude forward from the sleeve.

The polishing tool holder in this literature has a nut moving mechanism configured to move the nut along the bolt portion in the axial direction. The nut moving mechanism has a nut rotation regulating mechanism configured to regulate the rotation of the nut relative to the sleeve, and an operating member configured to rotate the shaft relative to the sleeve. The operating member is a gear fixed coaxially to the shaft. The gear includes a gear portion exposed outward from the polishing tool holder.

When polishing a workpiece, a polishing device is connected to the spindle of a machine tool. The machine tool moves the polishing device closer to the workpiece while rotating the polishing device and brings the grinding members into contact with a surface to be polished of the workpiece. When finishing polishing the surface to be polished, the machine tool moves the polishing device away from the workpiece and stops the rotation of the polishing device.

In this literature, the machine tool performs a grinding member protruding operation when the grinding members are worn by the polishing operation. In the grinding member protruding operation, the machine tool moves the polishing device in a rotation stop state to a position for adjusting the protruding amount of the grinding members. The machine tool moves the polishing device by a predetermined amount by allowing a rack gear disposed at the position for adjusting the protruding amount of the grinding members to mesh with the gear portion of the gear exposed from the polishing tool holder. As a result, the shaft of the polishing tool holder rotates, so the nut moves forward in the axial direction. Thus, the polishing tool connected to the nut moves forward, and the grinding members protrude forward from the sleeve.

### Citation List

### Patent Literature

Patent Literature 1: WO 2015/178273

### SUMMARY

### Technical Problem

In a manufacturing line for manufacturing objects, a polishing process is sometimes performed to polish a plurality of identical parts (workpieces) in succession, one after another. In other words, in a manufacturing line, a polishing process is sometimes performed to repeatedly perform an identical polishing operation while replacing parts (workpieces).

When such a polishing process is performed with the polishing device described above, a first workpiece is first disposed in a predetermined processing position, and a polishing operation is performed on the first workpiece. In the polishing operation, the machine tool brings the polishing device 1 and the first workpiece closer to each other while rotating the polishing device, so that the distance between the spindle of the machine tool and the first workpiece is a setting distance. The setting distance is the distance at which the grinding member of the polishing tool held in the polishing tool holder is in contact with the surface to be polished of the workpiece at a predetermined depth of cut. The machine tool moves the polishing device along a predetermined polishing path while maintaining the distance between the spindle and the first workpiece at the setting distance. Thereafter, when the polishing operation for the first workpiece is finished, the machine tool moves the polishing tool holder away from the first workpiece and replaces the first workpiece in the processing position with a second workpiece. The machine tool also performs a grinding member protruding operation. In other words, the machine tool moves the polishing device to the position for adjusting the protruding amount of the grinding member, allows the rack gear to mesh with the gear portion of the gear of the polishing tool holder to move the polishing device, and rotates the gear. As a result, the shaft of the polishing tool holder rotates, so the polishing tool moves in the axial direction by the amount corresponding to the rotation of the gear, whereby the grinding member protrudes forward.

Next, the polishing operation for the second workpiece is performed. In other words, the machine tool brings the polishing device and the second workpiece closer to each other while rotating the polishing device, so that the distance between the spindle of the machine tool and the second workpiece is the setting distance. The machine tool then moves the polishing device along a predetermined polishing path while maintaining the distance between the spindle and the first workpiece at the setting distance. Thereafter, when the polishing operation for the second workpiece is finished, the machine tool moves the polishing tool holder away from the second workpiece and replaces the second workpiece in the processing position with a third workpiece. The machine tool also performs the grinding member protruding operation. In other words, the machine tool moves the polishing device to the position for adjusting the protruding amount of the grinding member, allows the rack gear to mesh with the gear portion of the gear of the polishing tool holder to move the polishing device, and rotates the gear. As a result, the shaft of the polishing tool holder rotates, so the polishing tool moves in the axial direction by the amount corresponding to the rotation of the gear, whereby the grinding member protrudes forward. The polishing operation for the third workpiece is then performed. In the polishing process, such a series of operations is repeated until there are no more workpieces to be polished.

In this way, when a conventional polishing device is used in a polishing process, it is necessary to move the polishing device to the position for adjusting the protruding amount of the grinding member and perform the grinding member protruding operation every time the polishing operation for one workpiece is finished. Thus, the takt time required to polish one workpiece is long.

For example, in a case where the grinding member is linear grinding members, the wear amount of the grinding member worn in a single polishing operation differs depending on the bristle length of the grinding member (the length dimension of the linear grinding member), even when an identical polishing operation is performed to polish parts with an identical shape. In the polishing process described above, therefore, every time the polishing operation for one workpiece is finished, the protruding amount by which the grinding member is protruded has to be changed based on the length dimension of the grinding members at the start of polishing of the workpiece. In other words, the grinding member has to be protruded by the amount corresponding to the wear amount by adjusting the rotation amount by which the gear is rotated, based on the length dimension of the linear grinding member at the start of polishing of the workpiece.

Here, if the protruding amount of the grinding member by the grinding member protruding operation does not correspond to the wear amount of the grinding member worn by the polishing operation for the previous workpiece, when the distance between the spindle of the machine tool and the second workpiece is set to the setting distance at the start of polishing of the next workpiece, the depth of cut of the grinding member for the next workpiece differs from the depth of cut of the grinding member for the previous workpiece. This causes variations in accuracy of polishing among a plurality of workpieces polished in the polishing process.

In view of the above problem, a polishing tool holder is provided that can automatically perform protrusion of a grinding member and prevent or suppress variations in accuracy of polishing for each workpiece when performing a polishing process of performing an identical polishing operation multiple times in succession while replacing workpieces. A polishing device including such a polishing tool holder and a polishing tool is also provided. A polishing system is further provided that can automatically perform protrusion of a grinding member of a polishing device and prevent or suppress variations in accuracy of polishing for each workpiece when performing a polishing process of performing an identical polishing operation multiple times in succession while replacing workpieces.

### Solution to Problem

In order to solve the above problem, the present invention provides a polishing tool holder including a shank connectable to a spindle of a machine tool, a support mechanism configured to support a polishing tool including a grinding member holder and a grinding member held in the grinding member holder such that the polishing tool is movable in an axial direction of the shank, a drive source, and a moving mechanism configured to move the polishing tool in the axial direction. The polishing tool holder includes a control unit configured to drive and control the drive source, a storage unit connected to the control unit, a rotation detector configured to detect a rotation state of being rotated by the machine tool, and a power supply configured to supply power to the drive source and the control unit. The storage unit stores and retains a reference dimension, a polishing operation count, and a wear pattern. The reference dimension is a dimension of the grinding member at a point in time when the polishing tool is supported on the support mechanism. The polishing operation count is a number of times the rotation detector detects the rotation state. The wear pattern associates a wear amount by which the grinding member with the reference dimension is worn by a single polishing operation of polishing a workpiece with the polishing operation count. The control unit includes: a polishing operation count updating unit configured to, when the rotation detector detects the rotation state, calculate a new polishing operation count by adding 1 to the polishing operation count and update the polishing operation count in the storage unit; a wear amount acquiring unit configured to, when the polishing operation count is calculated, acquire the wear amount by referring to the wear pattern based on the polishing operation count; and a drive control unit configured to, when termination of the rotation state is detected based on an output from the rotation detector, perform a grinding member protruding operation that drives the drive source and operates the moving mechanism to move the polishing tool to an opposite side of the shank by a distance corresponding to the wear amount.

According to the present invention, the polishing tool holder includes the drive source, the moving mechanism that moves the polishing tool supported on the support mechanism, the control unit that drives and controls the drive source, and the power supply that supplies power to the drive source and the control unit. Thus, the polishing tool holder can move the polishing tool in the axial direction by driving the moving mechanism through the drive control of the drive source by the control unit. As a result, the polishing tool holder can automatically perform the grinding member protruding operation of protruding the grinding member to the opposite side of the shank by moving the polishing tool in the axial direction.

According to the present invention, the storage unit stores and retains the reference dimension, which is a dimension of the grinding member at a point in time when the polishing tool is supported on the support mechanism, the polishing operation count, which is the number of times the rotation detector detects the rotation state, and the wear pattern in which the wear amount by which the grinding member with the reference dimension is worn by a single polishing operation of polishing a workpiece is associated with the polishing operation count. When the rotation detector detects the rotation state, the control unit updates the polishing operation count by adding 1 to the polishing operation count and acquires the wear amount by referring to the wear pattern based on the updated polishing operation count. When the termination of the rotation state is detected based on an output from the rotation detector, the control unit performs the grinding member protruding operation of protruding the grinding member by driving the drive source and operating the moving mechanism to move the polishing tool in the axial direction by a distance corresponding to the wear amount.

Here, for example, in a case where the grinding member is linear grinding members, the wear amount of the grinding member worn in a single polishing operation differs depending on the length dimension of the grinding member at the start of the polishing operation even when an identical polishing operation is performed to polish parts with an identical shape. In other words, in a case where the grinding member is linear grinding members, the shorter the length dimension of the grinding member at the start of the polishing operation, the more rigid the grinding member, and the more the wear amount by a single polishing operation. Thus, if the protruding amount of the grinding member protruded by the grinding member protruding operation (the amount of movement of the polishing tool) is constant, the depth of cut of the grinding member for the next workpiece changes, causing variations in accuracy of polishing among a plurality of workpieces polished in succession. In contrast, the polishing tool holder according to the present invention acquires the wear amount of the grinding member from the wear pattern stored and retained in the storage unit every time a single polishing operation is finished. The wear pattern associates the wear amount of being worn by a single polishing operation with the polishing operation count for the grinding member with the reference dimension at a point in time when the polishing tool is supported on the support mechanism. Thus, if the wear amount is acquired by referring to the wear pattern based on the polishing operation count, the acquired wear amount reflects the wear amount of the grinding member that varies with the length dimension of the linear grinding members at the start of the polishing operation. As a result, the protruding amount of the grinding member in the grinding member protruding operation can be matched to the wear amount by which the grinding member is worn by polishing of the previous workpiece. Thus, by allowing the polishing tool holder according to the present invention to hold the polishing tool, protrusion of the grinding member can be performed automatically and variations in accuracy of polishing for each workpiece can be prevented or suppressed in a polishing process of performing the identical polishing operation in succession multiple times while replacing the workpieces.

In the present invention, the drive control unit may perform the grinding member protruding operation when termination of the rotation state is detected. In other words, when the polishing operation for one workpiece is finished, the grinding member protruding operation can be performed in succession.

In the present invention, when termination of the rotation state is detected, the drive control unit may perform the grinding member protruding operation next time the rotation detector detects the rotation state. In other words, the grinding member protruding operation can be performed after the polishing operation for one workpiece is finished and when the machine tool rotates the polishing device for the polishing operation for the next workpiece.

In the present invention, the polishing tool holder may further include a notifying unit. The control unit may include: a grinding member length dimension calculating unit configured to, when the wear amount is acquired for the first time, calculate a grinding member length dimension by subtracting the wear amount from the reference dimension and store and retain the calculated grinding member length dimension into the storage unit, and thereafter every time the wear amount is acquired, calculate a new grinding member length dimension by subtracting the wear amount from the grinding member length dimension and update the grinding member length dimension in the storage unit; a replacement determining unit configured to, every time the grinding member length dimension is calculated, determine whether the polishing tool needs to be replaced based on the grinding member length dimension and the reference dimension; and a replacement notifying unit configured to, when the replacement determining unit determines that the polishing tool needs to be replaced, drive the notifying unit to indicate that the polishing tool needs to be replaced. In other words, the control unit calculates the grinding member length dimension of the grinding member at the end every time the polishing operation is finished, and determines whether replacement is necessary based on the grinding member length dimension and the reference dimension. If it is determined that replacement is necessary, the control unit drives the notifying unit to indicate that the polishing tool needs to be replaced.

In the present invention, the polishing tool holder may further include a communication unit configured to perform communication with an external device. The reference dimension and the wear pattern may be input to the control unit via the communication unit and stored and retained in the storage unit. In this case, the communication unit can perform wireless communication with an external device. Further, the communication unit can perform wired communication with an external device.

In the present invention, the rotation detector may be an accelerometer.

The rotation detector may be a vibration sensor. When the polishing tool holder is rotated by the machine tool, vibration is generated in the polishing tool holder. Thus, the rotation state of the polishing tool holder can be detected by detecting this vibration.

In the present invention, the rotation detector may be a switch that includes a conductive member movable by centrifugal force, and the conductive member connects or disconnects a circuit.

In the present invention, the support mechanism may include a connecting member having a through hole passing through in the axial direction, and a shaft member passing through the through hole coaxially with the shank and extending in the axial direction. The drive source may be a motor. The moving mechanism may include a rotational support mechanism configured to support the shaft member such that the shaft member is rotatable about an axis of the shank, a female thread on an inner peripheral surface of the through hole, a male screw on an outer peripheral surface of the shaft member, the male screw being screwed to the female thread, a drive force transmitting mechanism configured to transmit rotation of the motor to the shaft member, a sleeve configured to guide the connecting member in the axial direction on an outer peripheral side of the connecting member and the shaft member, and a rotation regulating mechanism configured to regulate co-rotation of the connecting member and the shaft member. The polishing tool may have the grinding member holder connected to the connecting part, the grinding member partially protruding outward from the sleeve. The control unit may drive the motor to rotate the shaft member to move the connecting member in the axial direction.

A polishing device according to the present invention includes the polishing tool holder described above, and a polishing tool including a grinding member holder and a grinding member held in the grinding member holder. The grinding member includes a plurality of linear grinding members arranged in parallel with a length direction aligned with the axial direction. The grinding member holder holds one end in the axial direction of each of the linear grinding members. The polishing tool is supported by the polishing tool holder to polish a workpiece by bringing another end of each of the linear grinding members into contact with the workpiece.

A polishing device according to the present invention includes the polishing tool holder described above, and a polishing tool including a grinding member holder and a grinding member held in the grinding member holder. The grinding member is an elastic grinder. The grinding member holder holds one end in the axial direction of the elastic grinder. The polishing tool is supported by the polishing tool holder to polish a workpiece by bringing another end of the elastic grinder into contact with the workpiece. In this case, the elastic grinder contains an elastic foam, a polymer, and abrasive grains.

A polishing device according to the present invention includes the polishing tool holder described above, and a polishing tool including a grinding member holder and a grinding member held in the grinding member holder. The grinding member is a rigid grinder. The grinding member holder holds one end in the axial direction of the grinder. The polishing tool is supported by the polishing tool holder to polish a workpiece by bringing another end of the grinder into contact with the workpiece.

The present invention provides a polishing system including: a polishing device including a polishing tool including a grinding member holder and a grinding member held in the grinding member holder, and a polishing tool holder including a shank connectable to a spindle of a machine tool, a support mechanism configured to support the polishing tool such that the polishing tool is movable in an axial direction of the shank, a drive source, and a moving mechanism configured to move the polishing tool in the axial direction; and a cloud computer communicatively connected to the polishing tool holder via a network. The polishing tool holder includes a control unit configured to drive and control the drive source based on a drive command, a rotation detector configured to detect a rotation state of being rotated by the machine tool, a power supply configured to supply power to the drive source and the control unit, and a communication unit configured to perform communication with the cloud computer. The communication unit transmits an output from the rotation detector to the cloud computer, receives the drive command from the cloud computer, and inputs the drive command to the control unit. The cloud computer includes a storage unit and a polishing device control unit. The storage unit is configured to store and retain a reference dimension, a polishing operation count, and a wear pattern. The reference dimension is a dimension of the grinding member at a point in time when the polishing tool is supported on the support mechanism. The polishing operation count is a number of times the rotation detector detects the rotation state. The wear pattern associates a wear amount by which the grinding member with the reference dimension is worn by a single polishing operation of polishing a workpiece with the polishing operation count. The polishing device control unit includes: a polishing operation count updating unit configured to, when the rotation detector detects the rotation state, calculate a new polishing operation count by adding 1 to the polishing operation count and update the polishing operation count in the storage unit; a wear amount acquiring unit configured to, when the polishing operation count is calculated, acquire the wear amount by referring to the wear pattern based on the polishing operation count; a drive command issuing unit configured to, when termination of the rotation state is detected based on an output from the rotation detector, issue the drive command to perform a grinding member protruding operation that drives the drive source and operates the moving mechanism to move the polishing tool to an opposite side of the shank by a distance corresponding to the wear amount; and a command transmitting unit configured to, when the drive command is issued, transmit the drive command to the polishing tool holder.

The polishing system according to the present invention includes the polishing device including the polishing tool holder and the polishing tool, and the cloud computer connected to the polishing tool holder via the network. The polishing device control unit of the cloud computer includes the drive command issuing unit that issues a drive command. The polishing tool holder includes the drive source, the moving mechanism that moves the polishing tool supported on the support mechanism, the control unit that drives and controls the drive source based on a drive command, and the power supply that supplies power to the drive source and the control unit. Thus, the polishing system can drive the moving mechanism of the polishing tool holder based on a drive command from the cloud computer and move the polishing tool in the axial direction. As a result, the polishing device can automatically perform the grinding member protruding operation of protruding the grinding member to the opposite side of the shank by moving the polishing tool in the axial direction.

In the present invention, the cloud computer that can communicate with the polishing tool holder acquires the wear amount of the grinding member from the wear pattern stored and retained in the storage unit of the cloud computer every time a single polishing operation is finished in the polishing device. Further, when the wear amount is acquired, the cloud computer issues a drive command to perform the grinding member protruding operation that drives the drive source of the polishing device and operates the moving mechanism to move the polishing tool to the opposite side of the shank by a distance corresponding to the wear amount, and transmits the drive command to the polishing tool holder. When receiving the drive command, the polishing device drives the drive source to perform the grinding member protruding operation. Here, the wear pattern associates the wear amount of being worn by a single polishing operation with the polishing operation count for the grinding member with the reference dimension at a point in time when the polishing tool is supported on the support mechanism. Thus, if the wear amount is acquired by referring to the wear pattern based on the polishing operation count, the acquired wear amount reflects the wear amount of the grinding member that varies with the length dimension of the linear grinding members at the start of the polishing operation. As a result, the protruding amount of the grinding member in the grinding member protruding operation can be matched to the wear amount by which the grinding member is worn by polishing of the previous workpiece. Thus, the polishing system according to the present invention can automatically perform protrusion of the grinding member and prevent or suppress variations in accuracy of polishing for each workpiece in a polishing process of performing the identical polishing operation in succession multiple times while replacing the workpieces.

In the present invention, the drive command issuing unit may issue the drive command when termination of the rotation state is detected. In other words, when the polishing operation for one workpiece is finished, the cloud computer issues and transmits a drive command to cause the polishing device to perform the grinding member protruding operation.

In the present invention, when termination of the rotation state is detected, the drive command issuing unit may issue the drive command next time the rotation detector detects the rotation state. In other words, after the polishing operation for one workpiece is finished and when the machine tool rotates the polishing device for the polishing operation for the next workpiece, the cloud computer can issue and transmit a drive command to cause the polishing device to perform the grinding member protruding operation.

In the present invention, the polishing tool holder may include a notifying unit. The polishing device control unit may include: a grinding member length dimension calculating unit configured to, when the wear amount is acquired for the first time, calculate a grinding member length dimension by subtracting the wear amount from the reference dimension and store and retain the calculated grinding member length dimension into the storage unit, and thereafter every time the wear amount is acquired, calculate a new grinding member length dimension by subtracting the wear amount from the grinding member length dimension and update the grinding member length dimension in the storage unit; a replacement determining unit configured to, every time the grinding member length dimension is calculated, determine whether the polishing tool needs to be replaced based on the grinding member length dimension and the reference dimension; and a notification command issuing unit configured to, when the replacement determining unit determines that the polishing tool needs to be replaced, drive the notifying unit to issue a notification command to indicate that the polishing tool needs to be replaced. When the notification command is issued, the command transmitting unit may transmit the notification command to the polishing tool holder.

In the present invention, the support mechanism may include a connecting member having a through hole passing through in the axial direction, and a shaft member passing through the through hole coaxially with the shank and extending in the axial direction. The drive source may be a motor. The moving mechanism may include a rotational support mechanism configured to support the shaft member such that the shaft member is rotatable about an axis of the shank, a female thread on an inner peripheral surface of the through hole, a male screw on an outer peripheral surface of the shaft member, the male screw being screwed to the female thread, a drive force transmitting mechanism configured to transmit rotation of the motor to the shaft member, a sleeve configured to guide the connecting member in the axial direction on an outer peripheral side of the connecting member and the shaft member, and a rotation regulating mechanism configured to regulate co-rotation of the connecting member and the shaft member. The polishing tool may have the grinding member holder connected to the connecting part, the grinding member partially protruding outward from the sleeve. The control unit may drive the motor to rotate the shaft member to move the connecting member in the axial direction.

In the present invention, the polishing system may include, as the polishing device, a first polishing device and a second polishing device communicatively connected to the cloud computer via a network. The cloud computer may include, as the polishing device control unit, a first polishing device control unit configured to receive an output from the rotation detector of the first polishing device and transmit the drive command to the first polishing device, and the polishing device control unit configured to receive an output from the rotation detector of the second polishing device and transmit the drive command to the second polishing device. With this configuration, in a case where a first machine tool and a second machine tool that perform the identical polishing process are provided as the machine tool, the first polishing device is connected to the first machine tool, and the second polishing device is connected to the second machine tool, these polishing devices can be driven and controlled by one cloud computer. The grinding member protruding operation for each polishing device can be performed by acquiring the wear amount of the grinding member based on one polishing pattern stored and retained in the storage of the cloud computer. Further, the wear pattern of each polishing device can be changed collectively by updating the wear pattern in the storage unit. With this configuration, the wear state of the grinding members of a plurality of polishing devices can be grasped on the cloud computer side. Thus, a plurality of polishing devices connected to the respective machine tools can be centrally controlled. With this configuration, outputs from the rotation detectors of a plurality of polishing devices are gathered in the cloud computer. Thus, on the cloud computer side, the operating state of each machine tool can be grasped based on the rotation state of each polishing device.

### BRIEF DESCRIPTION OF DRAWINGS

FIG. 1 is a perspective view of a polishing device in Example 1 to which the present invention is applied.

FIG. 2 is a perspective view of a polishing brush which is a polishing tool of the polishing device in Example 1.

FIG. 3 is an illustration of an overall structure of the polishing device in FIG. 1.

FIG. 4 is an illustration of a polishing operation using the polishing device.

FIG. 5 is a graph of a wear pattern stored and retained in a storage unit in a polishing tool holder.

FIG. 6 is a flowchart of a polishing process.

FIG. 7 is a flowchart of an operation of the polishing tool holder in the polishing process.

FIG. 8 is a perspective view of a polishing device in Example 2 to which the present invention is applied.

FIG. 9 is a perspective view of a polishing tool of the polishing device in Example 2.

FIG. 10 is a graph of a wear pattern stored by the polishing device in Example 2.

FIG. 11 is a perspective view of a polishing device in Example 3 to which the present invention is applied.

FIG. 12 is a graph of a wear pattern stored by the polishing device in Example 3.

FIG. 13 is an illustration of a polishing system to which the present invention is applied.

FIG. 14 is a flowchart of an operation of the polishing system in a polishing process.

FIG. 15 is an illustration of a polishing system with a plurality of polishing devices.

### DESCRIPTION OF EMBODIMENTS

A polishing device according to embodiments of the present invention will be described below with reference to the drawings.

### Example 1

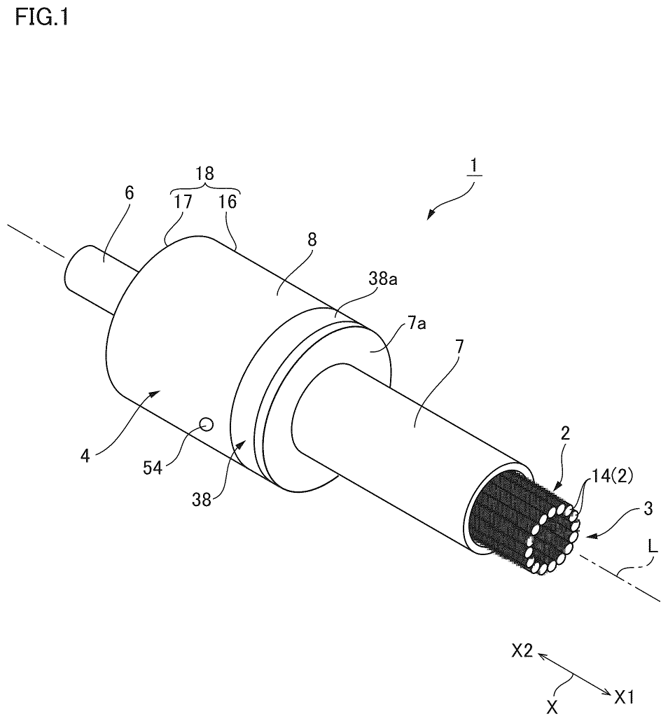

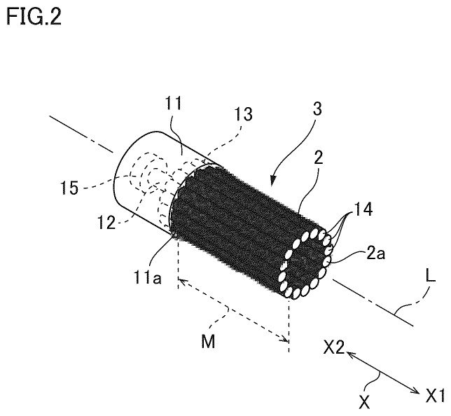

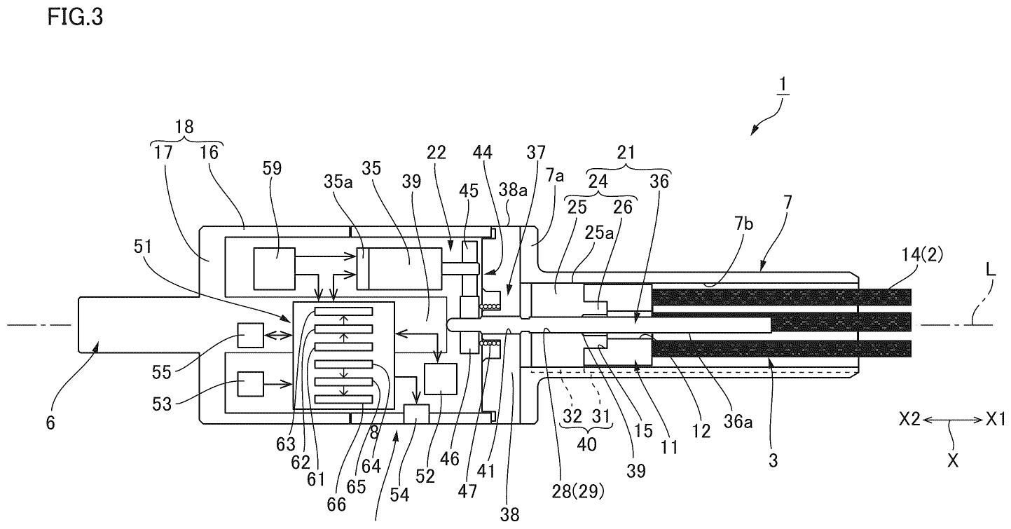

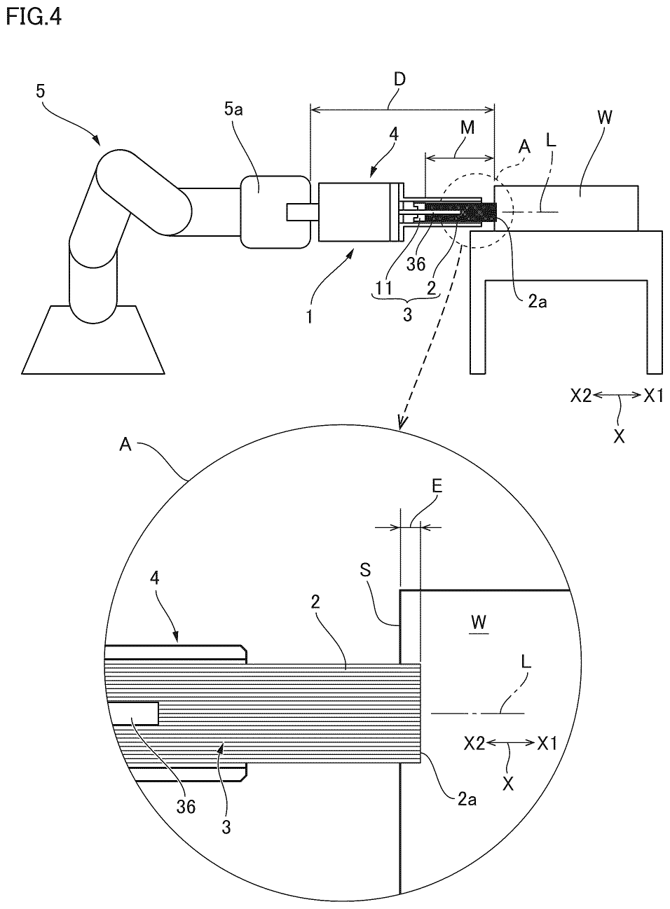

FIG. 1 is an external perspective view of a polishing device in Example 1 to which the present invention is applied. FIG. 2 is a perspective view of a polishing brush included in the polishing device. The polishing brush in FIG. 2 is an unused one. FIG. 3 is an illustration of an overall structure of the polishing device in FIG. 1. FIG. 3 illustrates the polishing device cut along an axis. FIG. 4 is an illustration of a polishing operation using the polishing device.

### Polishing Device

As illustrated in FIG. 1, a polishing device 1 has a polishing brush 3 (polishing tool) including a plurality of linear grinding members 2 (grinding member), and a polishing tool holder 4 that removably holds the polishing brush 3. The polishing tool holder 4 includes a shank 6 that is connected to a machine tool 5, and a sleeve 7 that is coaxial with the shank 6. Between the shank 6 and the sleeve 7, a large diameter section 8 is provided, which has a larger diameter than the shank 6 and the sleeve 7. The sleeve 7 has a flange 7a at its rear end. The flange 7a extends toward the outer peripheral side. The flange 7a defines a front end surface of the large diameter section 8. The polishing brush 3 is held in the polishing tool holder 4 with end portions of the linear grinding members 2 protruding forward from the sleeve 7.

As illustrated in FIG. 4, the polishing device 1 is used with the shank 6 of the polishing tool holder 4 connected to a spindle 5a of the machine tool 5. When a polishing operation is performed for a workpiece W, the machine tool 5 rotates the polishing device 1 about the axis of the shank 6. The machine tool 5 brings the polishing device 1 closer to the workpiece W, so that the distance between the spindle 5a and a surface S to be polished of the workpiece W is a setting distance D. The setting distance D is the distance at which the linear grinding members 2 of the polishing brush 3 are in contact with the surface S to be polished of the workpiece W at a predetermined depth of cut E. The machine tool 5 performs polishing for a predetermined duration while moving the polishing device 1 along a predetermined polishing path along the surface S to be polished while maintaining the distance between the spindle 5a and the workpiece W at the setting distance D. When the polishing operation for the workpiece W is finished, the machine tool 5 moves the polishing device 1 away from the workpiece W and stops the rotation of the polishing device 1.

In the following description, the direction along the axis L of the shank 6 is defined as the axial direction X of the polishing device 1. In the axial direction X, the front side of the polishing device 1 on the side where the sleeve 7 is located is defined as a first direction X1, and the back side of the polishing device where the shank 6 is located is defined as a second direction X2 of the polishing device 1.

### Polishing Brush

As illustrated in FIG. 2, the polishing brush 3 has a plurality of linear grinding members 2 disposed in parallel and a grinding member holder 11 that holds one end of each of the linear grinding members 2. The linear grinding members each extend in the axial direction X. The linear grinding members 2 are made by impregnating and curing aggregate yarn of inorganic filaments such as alumina filaments with a binder resin.

As illustrated in FIG. 3, the grinding member holder 11 is an annular member and has a holder through hole 12 extending in the axial direction X. As illustrated in FIG. 2, the grinding member holder 11 has a plurality of grinding member holding holes 13 on its end surface 11a in the first direction X1. Each of the grinding member holding holes 13 is circular. A plurality of grinding member holding holes 13 are provided at equiangular intervals around the axis L. A plurality of grinding member holding holes 13 surround the holder through hole 12. A plurality of linear grinding members 2 are divided into groups of several grinding members bundled together. Each of grinding member bundles 14 has a rear end portion inserted in the corresponding grinding member holding hole 13 and fixed to the grinding member holder 11 by adhesive.

As illustrated in FIG. 3, the grinding member holder 11 has a recess in its rear end surface. The recess is coaxial with the holder through hole 12 and has a larger inner diameter dimension than the holder through hole 12. The recess is a connecting part 15 for holding the polishing brush 3 in the polishing tool holder 4.

### Polishing Tool Holder

As illustrated in FIG. 3, the polishing tool holder 4 includes the shank 6, a support mechanism 21 that supports the polishing brush 3 such that the polishing brush 3 is movable in the axial direction X, and a moving mechanism 22 that moves the polishing brush 3 in the axial direction X. The moving mechanism 22 includes a motor 35 as its drive source. The motor 35 in this example is a geared motor and includes an encoder 35a.

The support mechanism 21 includes a connecting member 24 to which the polishing brush 3 is connected, and a shaft member 36 extending coaxially with the shank 6. The connecting member 24 has a through hole 28 passing through in the axial direction X. The through hole 28 has an inner peripheral surface having a female thread 29. The shaft member 36 passes through the through hole 28. The sleeve 7 is located on the outer peripheral side of the connecting member 24 and the shaft member 36. The connecting member 24 can move in the sleeve 7 in the axial direction X while being supported on the shaft member 36.

The connecting member 24 includes a disk part 25 and a protruding part 26 protruding in the first direction X1 from the center of the disk part 25. The disk part 25 has an annular facing surface 25a that faces an inner peripheral surface 7b of the sleeve 7 with a slight gap. The protruding part 26 has a shape that fits into the connecting part 15 of the polishing brush 3. The protruding part 26 is a connecting part on the connecting member side that connects the polishing brush 3 to the connecting member 24.

The polishing brush 3 is connected to the connecting member 24 with its connecting part 15 fitting on the protruding part 26 of the connecting member 24. When the polishing brush 3 is connected to the connecting member 24, the through hole 28 of the connecting member 24 is communicatively connected to the holder through hole 12. The inner diameter dimension of the holder through hole 12 is larger than the inner diameter dimension of the through hole 28 of the connecting member 24. In a state in which the polishing brush 3 is connected to the connecting member 24, the polishing brush 3 and the connecting member 24 are integrated. The polishing brush 3 is therefore supported by the support mechanism 21 movably in the axial direction X. Here, the polishing brush 3 and the connecting member 24 do not rotate relative to each other about the axis.

The moving mechanism 22 includes the motor 35. The moving mechanism 22 also includes a rotational support mechanism 37 that supports the shaft member 36 such that the shaft member 36 is rotatable about the axis, the female thread 29 provided on the inner peripheral surface of the through hole 28 of the connecting member 24, and a male screw 36a provided on the outer peripheral surface of the shaft member 36. The moving mechanism 22 further includes a drive force transmitting mechanism 44 that transmits the rotation of the motor 35 to the shaft member 36, and a rotation regulating mechanism 40 that regulates co-rotation of the sleeve 7 with the connecting member 24 and the shaft member 36 about the axis L.

The rotational support mechanism 37 includes a radial support member 38 that supports a portion in the second direction X2 of the shaft member 36 from the outer peripheral side such that the portion is rotatable, and a thrust support member 39 that supports the shaft member 36 from the second direction X2. The radial support member 38 is disk-shaped and has a shaft hole 41 at its center to allow the shaft member 36 to pass through in the axial direction X. The radial support member 38 is located between the drive force transmitting mechanism 44 and the connecting member 24 in the axial direction X. The rotational support mechanism 37 includes a biasing member 47 that biases the shaft member 36 toward the thrust support member 39. The biasing member 47 is a coil spring and is disposed between the radial support member 38 and a second gear 46 fixed to a rear end of the shaft member 36 while allowing the shaft member 36 to pass through the center of the biasing member 47. The biasing member 47 pushes the shaft member 36 against the thrust support member 39 by biasing the second gear 46 to the second direction X2.

Here, the large diameter section 8 of the polishing tool holder 4 has a housing 18 including a tubular part 16 and a sealing plate part 17 that seals an opening in the second direction X2 of the tubular part 16. The shank 6 protrudes in the second direction X2 from a central portion of the sealing plate part 17. The radial support member 38 is fixed to the tubular part 16 from the first direction X1 so as to seal an opening in the first direction X1 of the tubular part 16. The flange 7a of the sleeve 7 is fixed to an end surface in the first direction X1 of the radial support member 38. As illustrated in FIG. 1, an annular outer peripheral surface 38a facing radially outward in the radial support member 38 and an outer peripheral surface of the tubular part 16 constitute an outer peripheral surface of the large diameter section 8. As illustrated in FIG. 3, the motor 35, the thrust support member 39, and the drive force transmitting mechanism 44 are housed in an inner space of the large diameter section 8 defined by the housing 18 and the radial support member 38.

In the shaft member 36, the male screw 36a is provided on an outer peripheral surface of a shaft portion in the first direction X1 that is located in the first direction X1 relative to the radial support member 38. The male screw 36a can be screwed to the female thread 29 of the connecting member 24. The connecting member 24 is supported on the shaft member 36 with its female thread 29 screwed to the male screw 36a of the shaft member 36.

The drive force transmitting mechanism 44 includes a first gear 45 attached to an output shaft of the motor 35 and a second gear 46 meshing with the first gear 45. The second gear 46 is fixed coaxially with the shaft member 36 at an end portion in the second direction X2 of the shaft member 36. The rotation of the motor 35 is transmitted to the shaft member 36 through the first gear 45 and the second gear 46.

The sleeve 7 has a groove 31 extending in the axial direction X on the inner peripheral surface 7b. The connecting member 24 has a projection 32 at a circumferential portion of the annular facing surface 25a. The projection 32 protrudes toward the outer peripheral side and extends in the axial direction X. The connecting member 24 is disposed in the sleeve 7 with the projection 32 inserted into the groove 31 of the sleeve 7. Thus, when the connecting member 24 moves in the axial direction X, the connecting member 24 is guided along the groove 31. The groove 31 on the inner peripheral surface 7b of the sleeve 7 and the projection 32 on the outer peripheral surface of the connecting member 24 are the rotation regulating mechanism 40 that regulates co-rotation of the connecting member 24 and the shaft member 36 about the axis L.

Here, the polishing brush 3 is inserted into the sleeve 7 and held in the polishing tool holder 4 after the grinding member holder 11 is connected to the connecting member 24. When the polishing brush 3 is held in the polishing tool holder 4, the male screw 36a of the shaft member 36 is screwed to the female thread 29 of the connecting member 24. The shaft member 36 passes through the through hole 28 of the connecting member 24 and then extends in the axial direction X inside the holder through hole 12 of the grinding member holder 11 of the polishing brush 3. In a state in which the polishing brush 3 is held in the polishing tool holder 4, the grinding member holder 11 is located in the sleeve 7, and the end portions (free ends) in the first direction X1 of the linear grinding members 2 protrude from the sleeve 7 in the first direction X1.

### Control System

As illustrated in FIG. 3, a control system of the polishing tool holder 4 includes a control unit 51 including a CPU and a storage unit 52 connected to the control unit 51. The storage unit 52 is a rewritable nonvolatile memory. A rotation detector 53 is connected to the input side of the control unit 51. The rotation detector 53 detects a rotation state in which the polishing tool holder 4 is rotated by the machine tool 5. In this example, the rotation detector 53 is an accelerometer. The motor 35 is connected to the output side of the control unit 51. An output signal from the encoder 35a of the motor 35 is fed back to the control unit 51. A light emitter 54 (notifying unit) is connected to the output side of the control unit 51. The light emitter 54 includes an LED. In addition, a communication unit 55 is connected to the control unit 51. The communication unit 55 enables communication between the control unit 51 and an external device.

The storage unit 52 stores and retains a reference dimension M, which is a dimension of the linear grinding members 2 at a point in time when the polishing brush 3 is supported on the support mechanism 21, and a polishing operation count, which is the number of times the rotation detector 53 detects the rotation state. In this example, the reference dimension M is the length dimension (bristle length) of the linear grinding members 2 of the unused polishing brush 3 (see FIG. 2). Here, the length dimension of the linear grinding members 2 is a dimension from the end surface 11a in the first direction X1 of the grinding member holder 11 to a distal end 2a of the linear grinding member 2. The initial value of the polishing operation count is “0”. Here, the machine tool 5 rotates the polishing device 1 to bring the linear grinding members 2 into contact with the workpiece W when polishing the workpiece W. When finishing polishing the workpiece W, the machine tool 5 stops the rotation of the polishing device 1. Thus, the number of times the polishing device 1 is rotated by the machine tool 5 is the polishing operation count of the polishing operation performed.

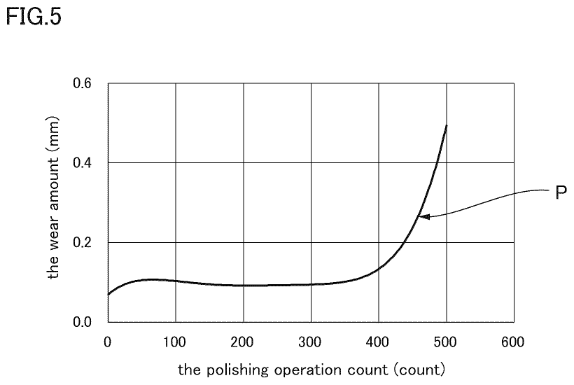

The storage unit 52 also stores and retains a wear pattern P in which the wear amount of being worn by a single polishing operation is associated with the polishing operation count for the linear grinding members 2 (the linear grinding members 2 of the unused polishing brush 3) with the reference dimension M. FIG. 5 illustrates the wear pattern P of the linear grinding members 2 when the identical polishing operation is performed multiple time by the polishing device 1 in this example while replacing the workpieces W. In FIG. 5, the horizontal axis represents the polishing operation count (count) and the vertical axis represents the wear amount (mm). The wear pattern P was obtained by actually performing the identical polishing operation multiple times in succession using the unused polishing brush 3 while replacing the workpieces W, and by measuring the wear amount of the linear grinding members 2 worn by each polishing operation. The wear pattern P is stored and retained in the storage unit 52 in the form of a mathematical formula. Alternatively, the wear pattern P is stored and retained in the storage unit 52 in the form of a table.

Here, in the polishing brush 3, even when an identical polishing operation is performed to polish parts with an identical shape, the wear amount of the grinding member worn by a single polishing operation varies depending on the length dimension of the linear grinding members 2 at the start of the polishing operation. The wear pattern P illustrated in FIG. 5 reflects such a variation in wear amount depending on the bristle length of the linear grinding members 2. In other words, when the dimension of the linear grinding members 2 of the polishing brush 3 is close to the reference dimension M (when the polishing operation count is small), the linear grinding members 2 easily bend during the polishing operation. Thus, when the polishing operation count is small, the wear amount of the linear grinding members 2 by a single polishing operation is relatively small. Subsequently, as the polishing operation count increases and the linear grinding members 2 become shorter, the bent of the linear grinding members 2 during the polishing operation becomes constant, and the wear amount of the linear grinding members 2 by a single polishing operation remains unchanged. After that, as the polishing operation count increases and the linear grinding members 2 become much shorter, the rigidity of the linear grinding members 2 increases and the linear grinding members 2 do not bend. Thus, when the polishing operation count exceeds a certain number, the wear amount of the linear grinding members 2 by a single polishing operation tends to increase.

As illustrated in FIG. 3, the control unit 51 includes a polishing operation count updating unit 61, a wear amount acquiring unit 62, and a drive control unit 63. The control unit 51 also includes a grinding member length dimension calculating unit 64, a replacement determining unit 65, and a replacement notifying unit 66.

When the rotation detector 53 detects the rotation state, the polishing operation count updating unit 61 calculates a new polishing operation count by adding 1 to the polishing operation count stored and retained in the storage unit 52 and updates the polishing operation count in the storage unit 52. When the polishing operation count is calculated, the wear amount acquiring unit 62 acquires the wear amount by referring to the wear pattern P based on the calculated polishing operation count.

When termination of the rotation state of the polishing device 1 is detected based on an output from the rotation detector 53, the drive control unit 63 performs a grinding member protruding operation. In other words, when a state in which the rotation detector 53 detects the rotation state transitions to a state in which the rotation state is not detected, the drive control unit 63 operates the moving mechanism 22 by driving the drive source to move the polishing tool in the first direction X1 by a distance corresponding to the wear amount acquired from the wear pattern P. As a result, the linear grinding members 2 are protruded in the first direction X1 by the wear amount. In this example, the drive control unit 63 performs the grinding member protruding operation when the termination of the rotation state is detected.

When the wear amount acquiring unit 62 acquires the wear amount for the first time, the grinding member length dimension calculating unit 64 calculates the grinding member length dimension by subtracting the wear amount from the reference dimension M, and stores and retains the calculated grinding member length dimension into the storage unit 52. Thereafter, every time the wear amount acquiring unit 62 acquires the wear amount, the grinding member length dimension calculating unit 64 calculates a new grinding member length dimension by subtracting the wear amount from the grinding member length dimension, and updates the grinding member length dimension in the storage unit 52.

Every time the grinding member length dimension is calculated, the replacement determining unit 65 determines whether the polishing brush 3 needs to be replaced based on the grinding member length dimension and the reference dimension M. For example, the replacement determining unit 65 determines that the polishing brush 3 needs to be replaced when the value obtained by subtracting the grinding member length dimension from the reference dimension M becomes shorter than a predetermined threshold. When the replacement determining unit 65 determines that the polishing brush 3 needs to be replaced, the replacement notifying unit 66 drives the light emitter 54 to indicate by light that the polishing brush 3 needs to be replaced.

The communication unit 55 uses a wireless network to perform communication between an external device and the control unit 51. The wireless network is, for example, that defined by standards such as IEEE 802.11. The initial values of the reference dimension M, the wear pattern P, and the polishing operation count are input to the control unit 51 from an external device via the communication unit 55. The control unit 51 stores and retains the input reference dimension M, wear pattern P, and polishing operation count in the storage unit 52.

Here, the polishing tool holder 4 includes a power supply 59 that supplies power to the motor 35, the control unit 51, the rotation detector 53, and the light emitter 54 in the inner space of the large diameter section 8. The power supply 59 is a battery. The battery is externally rechargeable by connecting a power cable. The polishing tool holder 4 has a not-illustrated connector for connecting the cable for the power supply 59.

### Operation of Polishing Tool Holder in Polishing Process

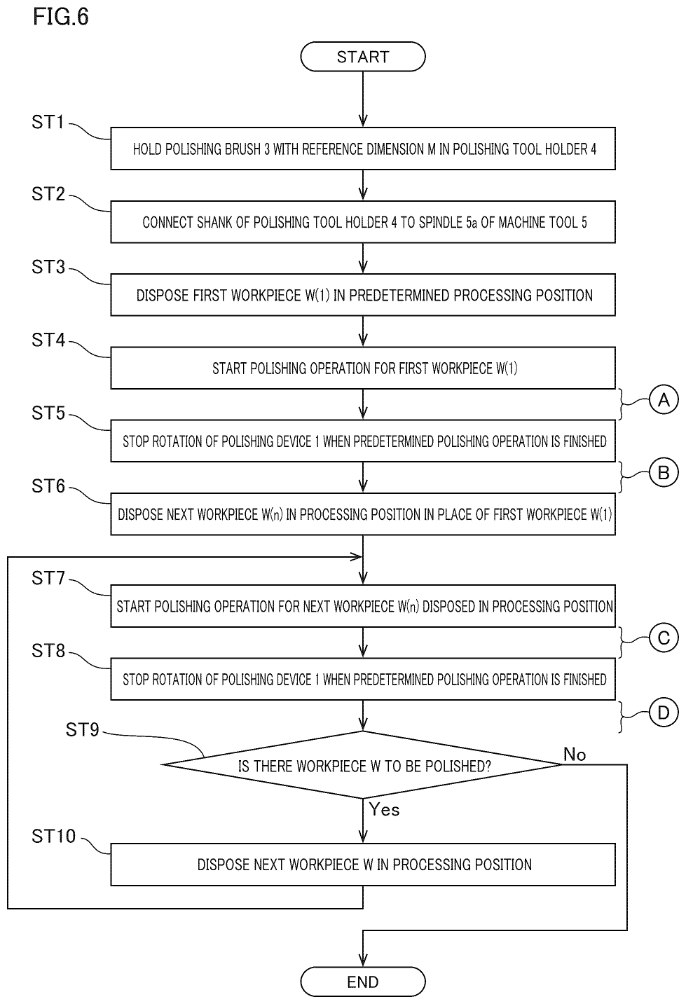

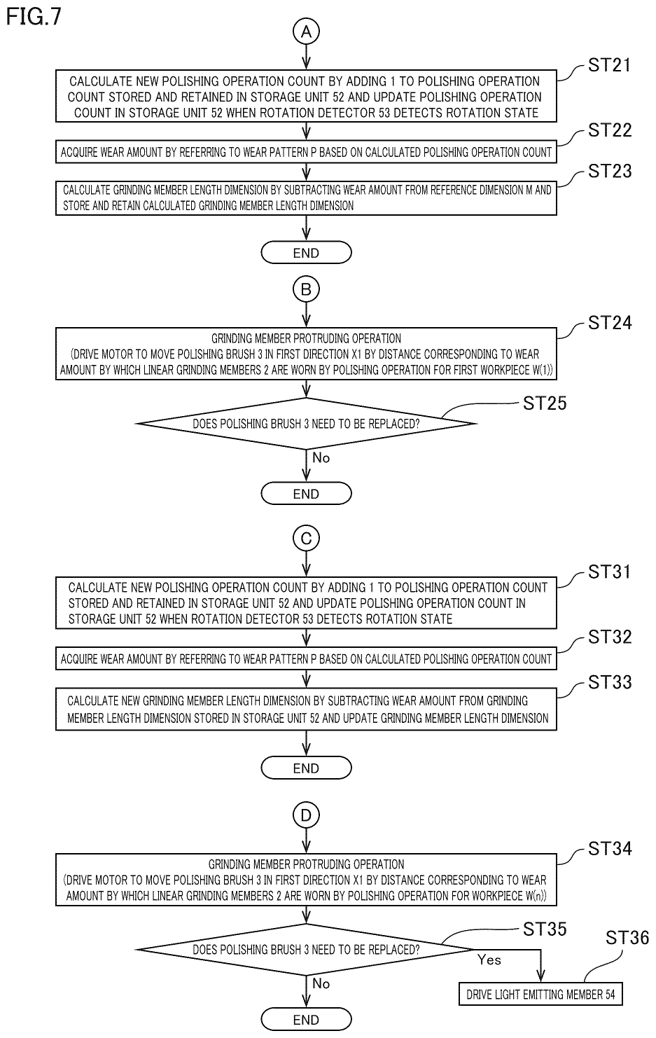

FIG. 6 is a flowchart of a polishing process. FIG. 7 is a flowchart of the operation of the polishing tool holder in the polishing process illustrated in FIG. 6.

In a manufacturing line for manufacturing objects, a polishing process is performed to perform an identical polishing operation for identical workpieces W multiple times in succession while replacing the workpieces W. The polishing device 1 in this example is suitable for use in such a polishing process.

When such a polishing process is performed using the polishing device 1, as illustrated in FIG. 4, an operator allows the polishing brush 3 (unused polishing brush 3) with the reference dimension M to be held in the polishing tool holder 4 (step ST1). Here, the storage unit 52 of the polishing tool holder 4 stores and retains the value of the bristle length of the unused polishing brush 3 as the reference dimension M in advance. The storage unit 52 of the polishing tool holder 4 also stores and retains the polishing operation count (0) in advance. The storage unit 52 of the polishing tool holder 4 further stores and retains the wear pattern P (see FIG. 4) in advance in which the wear amount of being worn by a single polishing operation is associated with the polishing operation count for the linear grinding members 2 with the reference dimension M (the linear grinding members 2 of the unused polishing brush 3).

Next, the operator connects the shank of the polishing tool holder 4 to the spindle 5a of the machine tool 5 (step ST2). Thereafter, the machine tool 5 disposes a first workpiece W in a predetermined processing position (step ST3). The machine tool 5 then starts the polishing operation for the first workpiece W(1) (step ST4).

In the polishing operation, the machine tool 5 brings the polishing device 1 closer to the workpiece W(1) while rotating the polishing device 1, so that the distance between the spindle 5a of the machine tool 5 and the surface S to be polished of the workpiece W(1) is the setting distance D. The setting distance D is the distance at which the linear grinding members 2 of the polishing brush 3 held in the polishing tool holder 4 connected to the spindle 5a are in contact with the surface S to be polished of the workpiece W(1) at a predetermined depth of cut E. The machine tool 5 polishes the workpiece W(1) for a predetermined duration while moving the polishing device 1 along a predetermined polishing path along the surface S to be polished while maintaining the distance between the polishing tool holder 4 and the surface S to be polished at the setting distance D.

Here, as illustrated in FIG. 7, when the rotation detector 53 detects the rotation state at step ST4, the control unit 51 of the polishing tool holder 4 calculates a new polishing operation count by adding 1 to the polishing operation count stored and retained in the storage unit 52, and updates the polishing operation count in the storage unit 52 with the calculated polishing operation count (step ST21). When the polishing operation count is calculated, the control unit 51 acquires the wear amount by referring to the wear pattern P in the storage unit 52 based on the calculated polishing operation count (step ST22). Further, when the wear amount is acquired, the control unit 51 calculates the grinding member length dimension by subtracting the wear amount from the reference dimension M, and stores and retains the calculated grinding member length dimension into the storage unit 52 (step ST23).

Thereafter, as illustrated in FIG. 6, when the polishing operation for the workpiece W(1) is finished, the machine tool 5 moves the polishing device 1 away from the workpiece W(1) and stops the rotation of the polishing device 1 (step ST5). The machine tool 5 disposes a next workpiece W in the processing position in place of the first workpiece W(1) (step ST6).

Here, when the termination of the rotation state of the polishing device 1 is detected based on an output from the rotation detector 53 at step ST5, the control unit 51 of the polishing tool holder 4 performs the grinding member protruding operation (step ST24). In the grinding member protruding operation, the control unit 51 drives the motor 35 to move the polishing brush 3 in the first direction X1 by a distance corresponding to the wear amount of the linear grinding members 2 worn by the polishing operation for the first workpiece W. As a result, the polishing tool holder 4 protrudes the linear grinding members 2 in the first direction X1. The control unit 51 also determines whether the polishing brush 3 needs to be replaced, based on the grinding member length dimension and the reference dimension M stored and retained in the storage unit 52 (step ST25). Since steps ST1 to ST5 are the polishing operation for the first workpiece W1, the linear grinding members 2 of the polishing brush 3 are sufficiently long at a point in time of step ST25. Thus, at step ST25, it is determined that the polishing brush 3 does not need to be replaced.

Thereafter, as illustrated in FIG. 6, the machine tool 5 starts the polishing operation for the next workpiece W(n) disposed in the processing position (step ST7). In other words, the machine tool 5 brings the polishing device 1 closer to the workpiece W(n) while rotating the polishing device 1, so that the distance between the spindle 5a and the workpiece W(n) is the setting distance D. As a result, the linear grinding members 2 of the polishing brush 3 are in contact with the surface S to be polished of the workpiece W(n) at a predetermined depth of cut E. The machine tool 5 performs polishing for a predetermined duration while moving the polishing device 1 along a predetermined polishing path along the surface S to be polished while maintaining the distance between the polishing tool holder 4 and the surface S to be polished at the setting distance D.

Here, as illustrated in FIG. 7, when the rotation detector 53 detects the rotation state at step ST7, the control unit 51 of the polishing tool holder 4 calculates a new polishing operation count by adding 1 to the polishing operation count stored and retained in the storage unit 52, and updates the polishing operation count in the storage unit 52 (step ST31). When the polishing operation count is calculated, the control unit 51 acquires the wear amount by referring to the wear pattern P based on the calculated polishing operation count (step ST32). Further, when the wear amount is acquired, the control unit 51 calculates a new grinding member length dimension by subtracting the wear amount from the grinding member length dimension stored in the storage unit 52, and updates the grinding member length dimension in the storage unit 52 (step ST33).

Thereafter, when the polishing operation for the workpiece W(n) is finished, as illustrated in FIG. 6, the machine tool 5 moves the polishing device 1 away from the workpiece W(n) and stops the rotation of the polishing device 1 (step ST8).

Here, the machine tool 5 determines whether there is a workpiece to be polished (step ST9).

If there is a workpiece to be polished (step ST9: Yes), the machine tool 5 disposes a next workpiece W in the processing position in place of the workpiece W(n) (step ST10). If there is no workpiece to be polished (step ST9: No), the polishing process ends.

Here, as illustrated in FIG. 7, when the termination of the rotation state of the polishing device 1 is detected based on an output from the rotation detector 53 at step ST8, the control unit 51 of the polishing tool holder 4 performs the grinding member protruding operation (step ST34). In the grinding member protruding operation, the control unit 51 moves the polishing brush 3 in the first direction X1 by a distance corresponding to the wear amount of the linear grinding members 2 worn by the polishing operation for the workpiece W. As a result, the polishing tool holder 4 protrudes the linear grinding members 2 in the first direction X1. The control unit 51 also determines whether the polishing brush 3 needs to be replaced, based on the grinding member length dimension and the reference dimension M stored and retained in the storage unit 52 (step ST35). When it is determined that the polishing brush 3 needs to be replaced, the control unit 51 drives the light emitter 54 to indicate by light that the polishing brush 3 needs to be replaced (step ST36). When the light emitter 54 emits light, the operator stops the machine tool 5 and replaces the polishing brush 3.

Thereafter, as illustrated in FIG. 6, the machine tool 5 performs the polishing operation for the next workpiece W disposed in the processing position (steps ST7 and ST8). In the polishing process, steps ST8 to ST11 are repeated until there is no more workpiece W to be polished (step ST9: No).

If the light emitted by the light emitter 54 indicates that the polishing brush 3 needs to be replaced (step ST36), the operator stops the machine tool 5 and replaces the polishing brush 3 with a new polishing brush 3. After that, the next workpiece W to be polished is set as the first workpiece W, and steps ST7 to ST10 are repeated until there is no more workpiece W to be polished.

### Operation Effects

According to this example, the polishing tool holder 4 includes the moving mechanism 22 that moves the polishing brush 3 supported on the support mechanism 21, the control unit 51 that drives and controls the motor 35, which is a drive source of the moving mechanism 22, and the power supply 59 that supplies power to the motor 35 and the control unit 51. Thus, the polishing tool holder 4 can move the polishing brush 3 in the axial direction X by driving the moving mechanism 22 through the drive control of the motor 35 by the control unit 51. As a result, the polishing tool holder 4 can automatically perform the grinding member protruding operation of protruding the linear grinding members 2 in the first direction X1 by moving the polishing brush 3 in the axial direction X.

The storage unit 52 of the polishing tool holder 4 stores and retains the reference dimension M, which is the dimension of the linear grinding members 2 at a point in time when the polishing brush 3 is supported on the support mechanism 21, the polishing operation count, which is the number of times the rotation detector 53 detects the rotation state, and the wear pattern P in which the wear amount by which the linear grinding members 2 with the reference dimension M are worn by a single polishing operation of polishing the workpiece W is associated with the polishing operation count. When the rotation detector 53 detects the rotation state, the control unit 51 updates the polishing operation count by adding 1 to the polishing operation count and acquires the wear amount by referring to the wear pattern P based on the updated polishing operation count. When the termination of the rotation state of the polishing device 1 is detected based on an output from the rotation detector 53, the control unit 51 performs the grinding member protruding operation of protruding the linear grinding members 2 by driving the motor 35 and operating the moving mechanism 22 to move the polishing brush 3 in the axial direction X by a distance corresponding to the wear amount.

Here, in a case where the grinding member of the polishing tool attached to the polishing tool holder 4 is the linear grinding members 2, even when an identical polishing operation is performed to polish parts with an identical shape, the wear amount of the linear grinding members 2 worn by a single polishing operation differs depending on the length dimension of the linear grinding members 2 at the start of the polishing operation. In other words, in a case where the grinding member is the linear grinding members 2, the shorter the length dimension of the linear grinding members 2 at the start of the polishing operation, the more rigid the linear grinding members 2, and the more the wear amount by a single polishing operation. Thus, if the protruding amount of the linear grinding members 2 protruded by the grinding member protruding operation (the amount of movement of the polishing brush 3) is constant, the depth of cut E of the linear grinding members 2 for the next workpiece W changes, causing variations in accuracy of polishing among a plurality of workpieces W polished in succession.

In contrast, the polishing tool holder 4 acquires the wear amount of the linear grinding members 2 from the wear pattern P stored and retained in the storage unit 52 every time a single polishing operation is finished. The wear pattern P associates the wear amount of being worn by a single polishing operation with the polishing operation count for the linear grinding members 2 with the reference dimension M at a point in time when the polishing brush 3 is supported on the support mechanism 21. The variation in the wear amount depending on the bristle length of the linear grinding members 2 is taken into account in the wear pattern P. Thus, if the wear amount is acquired by referring to the wear pattern P based on the polishing operation count, the acquired wear amount reflects the wear amount of the linear grinding members 2 that varies with the length dimension of the linear grinding members 2 at the start of the polishing operation. As a result, in the polishing tool holder 4 in this example, the protruding amount of the linear grinding members 2 in the grinding member protruding operation can be matched to the wear amount by which the linear grinding members 2 are worn by polishing of the previous workpiece W. Thus, by allowing the polishing tool holder 4 to hold the polishing brush 3, protrusion of the linear grinding members 2 can be performed automatically and variations in accuracy of polishing for each workpiece W can be prevented or suppressed in a polishing process of performing the identical polishing operation in succession multiple times while replacing the workpieces W.

The polishing tool holder 4 includes the light emitter 54. The control unit 51 includes the grinding member length dimension calculating unit 64 that calculates a grinding member length dimension by subtracting the wear amount from the reference dimension M and stores the calculated grinding member length dimension into the storage unit 52 when the wear amount is acquired for the first time, and thereafter calculates a new grinding member length dimension by subtracting the wear amount from the grinding member length dimension and updates the grinding member length dimension in the storage unit 52 every time the wear amount is acquired. The control unit also includes the replacement determining unit 65 that determines whether the polishing brush 3 needs to be replaced based on the grinding member length dimension and the reference dimension M every time the grinding member length dimension is calculated. If the polishing brush 3 needs to be replaced, the replacement determining unit 65 drives the light emitter 54 to indicate that the polishing brush 3 needs to be replaced. In other words, the control unit 51 calculates the grinding member length dimension of the linear grinding members 2 at the end every time the polishing operation is finished, and determines whether replacement is necessary based on the grinding member length dimension and the reference dimension M. If it is determined that replacement is necessary, the control unit 51 drives the light emitter 54 to indicate that the polishing brush 3 needs to be replaced. Thus, with the polishing tool holder 4, the operator easily recognizes the timing to replace the polishing brush 3.

The wear pattern P of the linear grinding members 2 illustrated in FIG. 5 is an example. Thus, the wear pattern P stored and retained in the storage unit 52 is not limited to this. In other words, the wear pattern P differs depending on the material of the linear grinding members 2.

### Modifications

The rotation detector 53 may be a vibration sensor. When the polishing tool holder 4 is rotated by the machine tool 5, vibration is generated in the polishing tool holder 4. Thus, the rotation state of the polishing tool holder 4 can be detected by a vibration sensor that detects this vibration.

The rotation detector 53 can be a switch that includes a conductive member movable by centrifugal force, and the conductive member connects or disconnects a circuit. In other words, the rotation detector 53 can be a switch in which when centrifugal force occurs, the conductive member moves toward the outer peripheral side and comes into contact with a contact of a circuit to electrically connect the circuit.

As a notifying unit to indicate that the polishing brush 3 needs to be replaced, a sounding unit including a buzzer or the like may be provided instead of the light emitter 54. In this case, when it is determined that the polishing brush 3 needs to be replaced, the replacement determining unit 65 drives the sounding unit to indicate by sound that the polishing brush 3 needs to be replaced.

The battery for the power supply 59 can be wirelessly rechargeable. Further, the power supply 59 may be removable from the polishing tool holder 4 and replaceable. A single battery may supply power to the motor 35 and the control unit 51. Alternatively, two batteries may be provided, namely, a battery for power supply to the motor 35 and a battery for power supply to the control unit 51.

Further, the communication unit 55 may perform communication between an external device and the control unit 51 via infrared communication or Bluetooth (registered trademark). The communication unit 55 may include a connector to which a communication cable is removably connected to enable communication between an external device and the control unit 51 via wired communication.

A direct drive mechanism may be employed, in which the motor 35 directly drives the shaft member 36. In this case, the drive force transmitting mechanism 44 is a connecting member that connects the output shaft of the motor 35 to the shaft member 36.

### Example 2

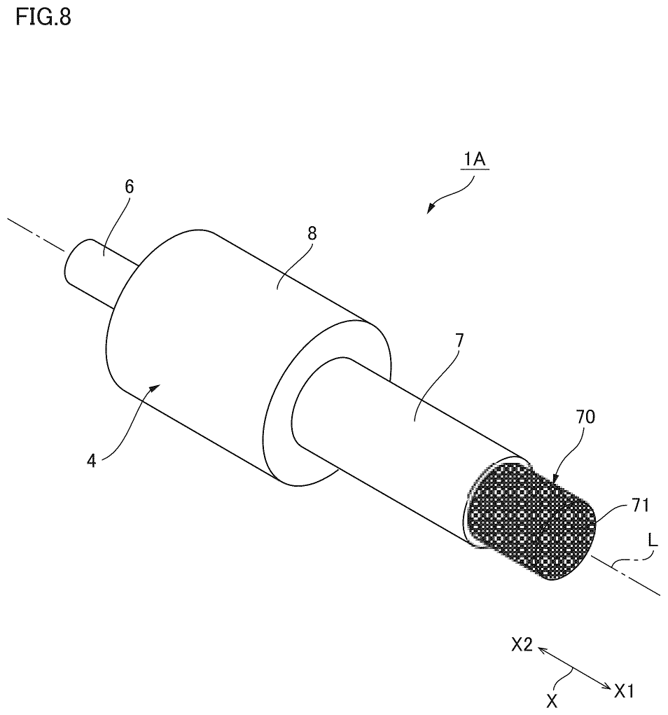

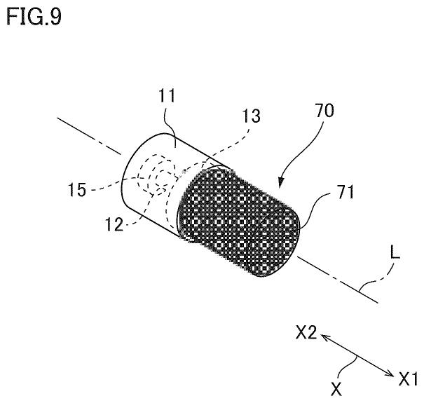

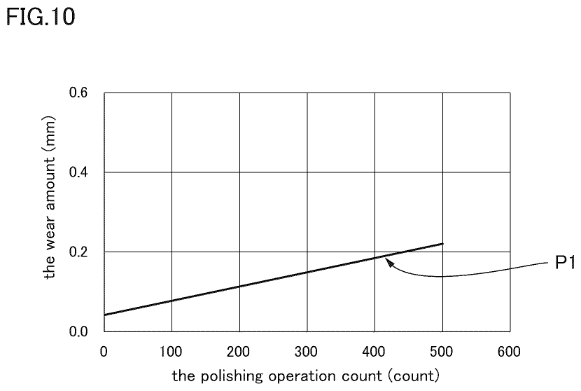

FIG. 8 is an external perspective view of a polishing device in Example 2 to which the present invention is applied. FIG. 9 is a perspective view of a polishing tool included in the polishing device in Example 2. FIG. 10 is a graph of a wear pattern stored and retained in the polishing tool holder in the polishing device in Example 2. As illustrated in FIG. 8 and FIG. 9, a polishing tool 70 of a polishing device 1A in Example 2 includes an elastic grinder 71 as the grinding member. Since the polishing device 1A has a configuration corresponding to that of the polishing device 1A in Example 1, the corresponding configuration is denoted by the same symbol and will not be further elaborated.

As illustrated in FIG. 8, the polishing device 1A has the polishing tool 70 and the polishing tool holder 4 that removably holds the polishing tool 70. As illustrated in FIG. 9, the polishing tool 70 has the grinding member holder 11 and the elastic grinder 71 held in the grinding member holder 11. The polishing tool holder 4 is identical to the polishing tool holder 4 of the polishing device 1A in Example 1, but a wear pattern Pl stored and retained in the storage unit 52 is different from the wear pattern P of the polishing device 1A in Example 1.

### Polishing Tool

As illustrated in FIG. 8, the polishing tool 70 includes the elastic grinder 71 as the grinding member. The elastic grinder 71 has a cylindrical shape extending in the axial direction X. The grinding member holder 11 holds one end in the axial direction X of the elastic grinder 71. The elastic grinder 71 contains an elastic foam, a polymer, and abrasive grains. In this example, the elastic foam is a melamine resin foam. In this example, the elastic foam is an anisotropic elastic foam that is compressed in one direction to impart anisotropy to elastic force.

The base material of the elastic grinder 71 is obtained by impregnating an anisotropic elastic foam with a dispersion containing a polymer and abrasive grains, and firing the impregnated elastic foam. In the anisotropic elastic foam, the direction with the strongest elastic force is the compression direction. The elastic grinder 71 is formed such that the compression direction of the anisotropic elastic foam coincides with the axial direction X when the polishing tool 70 is held in the polishing tool holder 4.

The polymer functions as a binding agent. The polymer is any one of epoxy resins, urethane resins, polyester resins, and polyrotaxane. In this example, the polymer is polyrotaxane. The abrasive grains are selected as appropriate depending on the type of workpiece W. Diamond, alumina, silica, silicon carbide, silicon nitride, boron carbide, titania, cerium oxide, or zirconia can be used as the abrasive grains. The grinding member is an organic substance such as walnut and synthetic resin. In this example, the abrasive grains are alumina.

As illustrated in FIG. 8, the grinding member holder 11 is an annular member having a holder through hole 12 extending in the axial direction X. The grinding member holder 11 has a single circular grinding member holding hole 13 at its front end surface. The grinding member holding hole 13 surrounds the holder through hole 12. An opening in the first direction X1 of the holder through hole 12 opens at the center of a circular bottom face of the grinding member holding hole 13. An end portion in the second direction X2 of the elastic grinder 71 is inserted in the grinding member holding hole 13 and fixed to the grinding member holder 11 by adhesive. The grinding member holder 11 has a recess in its rear end surface. The recess is coaxial with the holder through hole 12 and has a larger inner diameter dimension than the holder through hole 12. The recess is the connecting part 15 for holding the polishing tool 70 in the polishing tool holder 4.

The polishing tool 70 is connected to the connecting member 24 with its connecting part 15 fitting on the protruding part 26 of the connecting member 24. When the polishing tool 70 is connected to the connecting member 24, the through hole 28 of the connecting member 24 is communicatively connected to the holder through hole 12. In a state in which the polishing brush 3 is connected to the connecting member 24, the polishing brush 3 and the connecting member 24 are integrated. Here, the connecting member 24 is supported on the shaft member 36 with its female thread 29 screwed to the male screw 36a of the shaft member. With this configuration, the polishing tool 70 is supported on the support mechanism 21 movably in the axial direction X. The polishing tool 70 is supported on the support mechanism 21 in a posture in which the grinding member holder 11 is located in the sleeve 7 and an end portion in the first direction X1 of the elastic grinder 71 protrudes from the sleeve 7.

Here, the storage unit 52 of the polishing tool holder 4 stores and retains the reference dimension M, which is a dimension of the elastic grinder 71 at a point in time when the polishing tool 70 is supported on the support mechanism 21, the polishing operation count, which is the number of times the rotation detector 53 detects the rotation state, and the wear pattern P1 in which the wear amount of being worn by a single polishing operation is associated with the polishing operation count for the elastic grinder 71 (unused elastic grinder 71) with the reference dimension M. FIG. 10 illustrates the wear pattern P1 of the elastic grinder 71. According to the wear pattern P1 of the elastic grinder 71, as the dimension of the elastic grinder 71 becomes shorter (as the polishing operation count increases), the wear amount of being worn by a single polishing operation increases linearly.

The polishing device 1A in this example can achieve operation effects similar to those of the polishing device 1 in Example 1. In other words, the polishing device 1A can automatically perform protrusion of the elastic grinder 71 and can match the protruding amount of the elastic grinder 71 to the wear amount of the elastic grinder 71 worn by the polishing operation for the previous workpiece W, in a polishing process of performing the identical polishing operation in succession multiple times while replacing the workpieces W. This configuration can prevent or suppress variations in accuracy of polishing for each workpiece W. In the polishing device 1A in this example, the polishing tool 70 can be replaced at an appropriate timing.

### Example 3

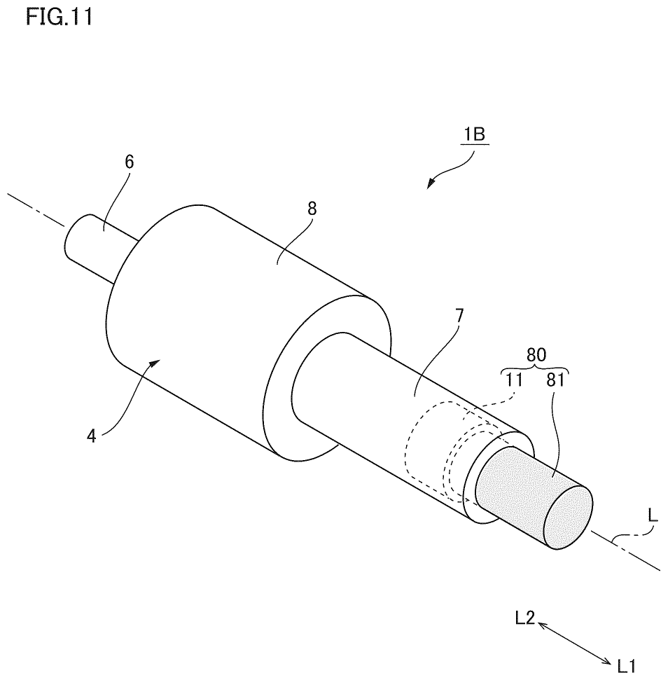

FIG. 11 is a perspective view of a polishing device in Example 3. A polishing tool 80 of a polishing device 1B in this example has a configuration in which the elastic grinder 71 of the polishing tool 70 in Example 2 is changed to a rigid grinder 81. In other words, the configuration of the polishing tool 80 is identical to that of the polishing tool 70, except for the grinding member.

As illustrated in FIG. 9, the polishing device 1B has the polishing tool 80 and the polishing tool holder 4 that removably holds the polishing tool 80. The polishing tool 80 includes the grinding member holder 11 and the rigid grinder 81 held in the grinding member holder 11. The grinder 81 is made of abrasive grains bonded with a bonding agent such as vitrified, or a natural grinding stone. The grinder 81 has a cylindrical shape extending in the axial direction X.

In the polishing device 1B, the polishing tool holder 4 is identical to the polishing tool holder 4 of the polishing device 1 in Example 1 and the polishing device 1A in Example 2, except for a wear pattern P2 stored and retained in the storage unit 52. Thus, the configuration of the polishing device 1B corresponding to that of the polishing devices 1 and 1A is denoted by the same sign and will not be further elaborated.

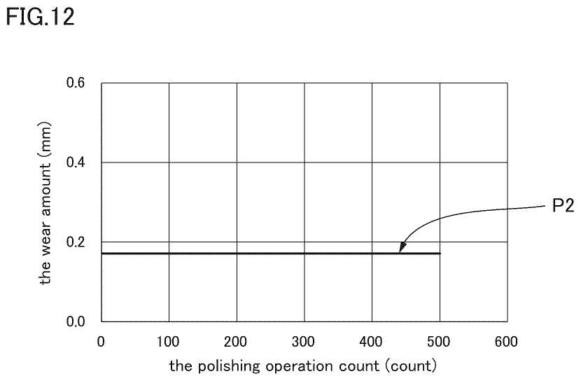

The storage unit 52 of the polishing tool holder 4 stores and retains the reference dimension M, which is a dimension of the grinder 81 at a point in time when the polishing tool 80 is supported on the support mechanism 21, the polishing operation count, which is the number of times the rotation detector 53 detects the rotation state, and the wear pattern P2 in which the wear amount of being worn by a single polishing operation is associated with the polishing operation count for the grinder 81 (unused grinder 81) with the reference dimension M. FIG. 12 illustrates the wear pattern P2 of the grinder 81. According to the wear pattern P2 of the grinder 81, the wear amount of being worn by a single polishing operation is constant, regardless of the dimension of the grinder 81 at the start of the polishing operation (regardless of the polishing operation count).

The polishing device 1B in this example can achieve operation effects similar to those of the polishing device 1A in Example 1. In other words, the polishing device 1A can automatically perform protrusion of the grinder 81 and can match the protruding amount of the grinder 81 to the wear amount of the grinder 81 worn by the polishing operation for the previous workpiece W, in a polishing process of performing the identical polishing operation in succession multiple times while replacing the workpieces W. This configuration can prevent or suppress variations in accuracy of polishing for each workpiece W. In the polishing device 1B in this example, the polishing tool 80 can be replaced at an appropriate timing.

### Polishing System

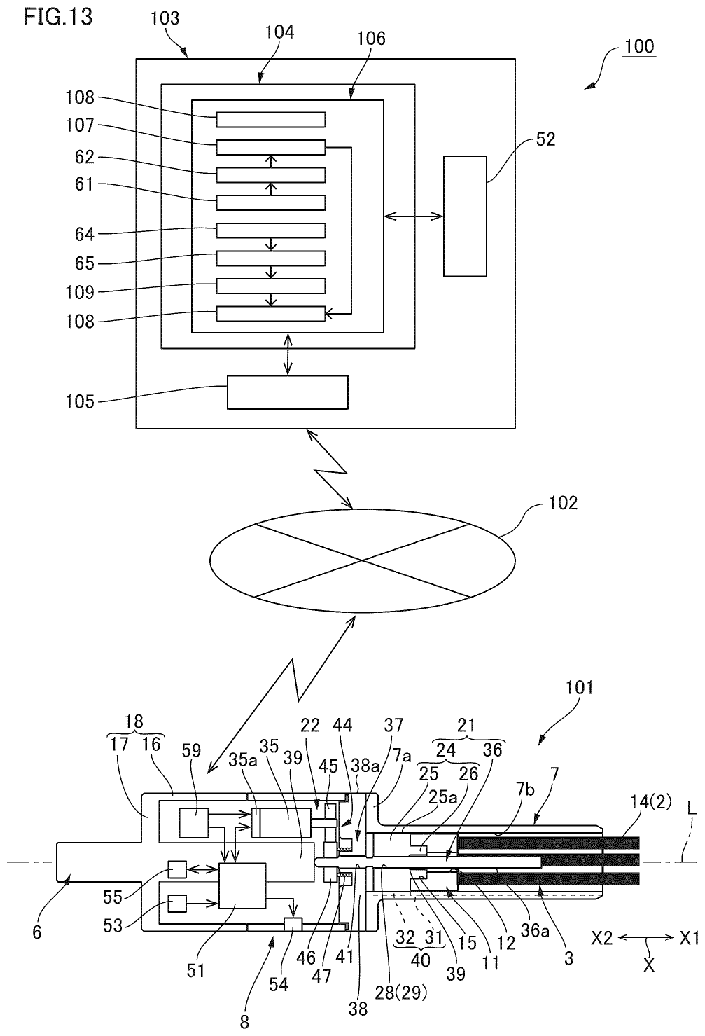

Referring now to FIG. 13, a polishing system in this example will be described. As illustrated in FIG. 13, a polishing system 100 in this example includes a polishing device 101 and a cloud computer 103 communicatively connected to the polishing device 101 via a network 102. The polishing device 101 has a polishing tool and the polishing tool holder 4 that holds the polishing tool. In this example, the polishing tool is the polishing brush 3. Thus, the grinding member of the polishing tool is the linear grinding members 2. The polishing device 101 has a configuration corresponding to that of the polishing device 1 in Example 1. Thus, the corresponding configuration is denoted by the same sign and will not be further elaborated.

### Polishing Brush

The polishing brush 3 is illustrated in FIG. 2. As illustrated in FIG. 13, the grinding member holder 11 of the polishing brush 3 is an annular member and has a holder through hole 12 extending in the axial direction X. The grinding member holder 11 has a plurality of grinding member holding holes 13 on its end surface 11a in the first direction X1. A plurality of linear grinding members 2 are divided into groups of several grinding members bundled together. Each of grinding member bundles 14 has a rear end portion inserted in the corresponding grinding member holding hole 13 and fixed to the grinding member holder 11 by adhesive. The grinding member holder 11 has a recess in its rear end surface. The recess is a connecting part 15 for holding the polishing brush 3 in the polishing tool holder 4.

The polishing tool holder 4 has a shank 6 to be connected to a spindle 5a of a machine tool 5. The polishing tool holder 4 includes a support mechanism 21 that supports the polishing brush 3 such that the polishing brush 3 is movable in the axial direction X of the shank 6, and a moving mechanism 22 including a motor 35 (drive source) to move the polishing brush 3 in the axial direction X. The polishing tool holder 4 further includes a light emitter 54 (notifying unit). The polishing tool holder 4 has a control unit 51, a rotation detector 53 that detects the rotation state of being rotated by the machine tool 5, and a power supply 59 that supplies power to the motor 35 and the control unit 51. These configurations are identical to those of the polishing tool holder 4 of the polishing device 1 in Example 1.

The polishing tool holder 4 further includes a control unit 51 and a communication unit 55 connected to the control unit 51. The control unit 51 drives and controls the motor 35 based on a drive command. The control unit 51 also drives and controls the light emitter 54 based on a notification command. The communication unit 55 performs communication with the cloud computer 103 via the network 102. The communication unit 55 transmits an output from the rotation detector 53 to the cloud computer 103, and receives a drive command and a notification command from the cloud computer 103 and inputs the same to the control unit 51.

In this example, the control unit 51 does not include the polishing operation count updating unit 61 and the wear amount acquiring unit 62. The control unit 51 does not include the grinding member length dimension calculating unit 64 and the replacement determining unit 65. Further, the polishing tool holder 4 does not include the storage unit 52.

On the other hand, the cloud computer 103 includes a storage unit 52. The storage unit 52 stores and retains the reference dimension M, which is a dimension of the grinding member at a point in time when the polishing brush 3 is supported on the support mechanism 21 of the polishing tool holder 4, the polishing operation count, which is the number of times the rotation detector 53 detects the rotation state, and the wear pattern P in which the wear amount by which the grinding member with the reference dimension M is worn by a single polishing operation of polishing a workpiece is associated with the polishing operation count. The initial values of the reference dimension M, the wear pattern P, and the polishing operation count are input from an external device to the cloud computer 103 via the network 102 and are stored and retained in the storage unit 52.

The cloud computer 103 includes a cloud computer-side control unit 104 and a cloud computer-side communication unit 105 connected to the cloud computer-side control unit 104. The cloud computer-side control unit 104 is communicatively connected to the storage unit 52. The cloud computer-side communication unit 105 communicates with an external device via the network 102. The cloud computer-side communication unit 105 enables communication between an external device and the cloud computer-side control unit 104.

The cloud computer-side control unit 104 includes a polishing device control unit 106. The polishing device control unit 106 includes a polishing operation count updating unit 61 and a wear amount acquiring unit 62. The polishing operation count updating unit 61 monitors an output from the rotation detector 53 of the polishing tool holder 4. When the rotation detector 53 detects the rotation state, the polishing operation count updating unit 61 calculates a new polishing operation count by adding 1 to the polishing operation count and updates the polishing operation count in the storage unit 52. When the polishing operation count is calculated, the wear amount acquiring unit 62 acquires the wear amount by referring to the wear pattern P in the storage unit 52 based on the calculated polishing operation count.

The polishing device control unit 106 also includes a drive command issuing unit 107 and a command transmitting unit 108. The drive command issuing unit 107 monitors an output from the rotation detector 53 of the polishing tool holder 4 and issues a drive command when the termination of the rotation state is detected based on an output from the rotation detector 53. The drive command is a command to perform a grinding member protruding operation that drives the motor 35 of the polishing device 101 and operates the moving mechanism 22 to move the polishing brush 3 to the opposite side of the shank 6 by a distance corresponding to the wear amount. When a drive command is issued, the command transmitting unit 108 transmits the drive command to the polishing tool holder 4. In this example, the drive command issuing unit 107 issues a drive command when the termination of the rotation state is detected based on an output from the rotation detector 53. When a drive command is issued, the command transmitting unit 108 transmits the drive command to the polishing device 1 without delay.

The polishing device control unit 106 further includes a grinding member length dimension calculating unit 64 and a replacement determining unit 65. When the wear amount is acquired for the first time, the grinding member length dimension calculating unit 64 calculates the grinding member length dimension by subtracting the wear amount from the reference dimension M and stores and retains the calculated grinding member length dimension in the storage unit 52. Thereafter, every time the wear amount is acquired, the grinding member length dimension calculating unit 64 calculates a new grinding member length dimension by subtracting the wear amount from the grinding member length dimension and updates the grinding member length dimension in the storage unit 52. Every time the grinding member length dimension is calculated, the replacement determining unit 65 determines whether the polishing brush 3 needs to be replaced based on the grinding member length dimension and the reference dimension M.

The polishing device control unit 106 also includes a notification command issuing unit 109. When the replacement determining unit 65 determines that the polishing brush 3 needs to be replaced, the notification command issuing unit 109 issues a notification command. The notification command is a command to drive the light emitter 54. When a notification command is issued, the command transmitting unit 108 transmits the notification command to the polishing tool holder 4.

### Operation of Polishing System in Polishing Process

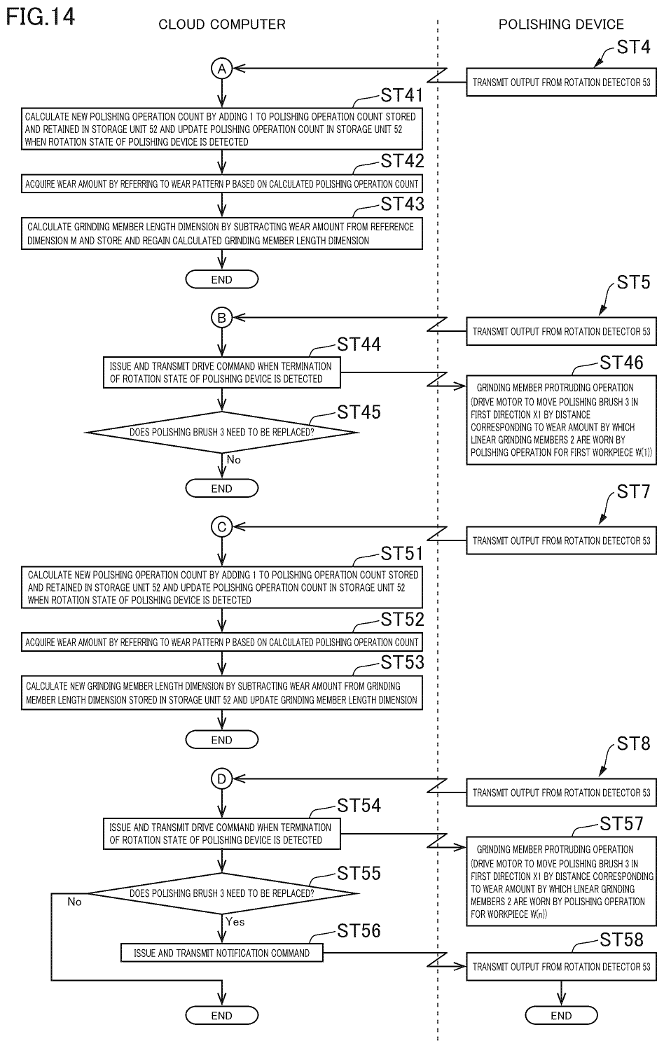

FIG. 14 is a flowchart of the operation of the polishing device 1 and the cloud computer 103 in the polishing process illustrated in FIG. 6. The flowchart of the polishing process when using the polishing system 100 is identical to the flowchart of the polishing process illustrated in FIG. 6. In the polishing system 100, the polishing device 1 (polishing tool holder 4) transmits an output from the rotation detector 53 to the cloud computer 103. The polishing device control unit 106 of the cloud computer 103 monitors an output from the rotation detector 53.

As illustrated in FIG. 6, when the polishing process is performed, an operator allows the polishing brush 3 (unused polishing brush 3) with the reference dimension M to be held in the polishing tool holder 4 (step ST1). Here, the storage unit 52 of the cloud computer 103 stores and retains the value of the bristle length of the unused polishing brush 3 as the reference dimension M in advance. The storage unit 52 of the cloud computer 103 also stores and retains the polishing operation count (0) in advance. The storage unit 52 of the cloud computer 103 further stores and retains the wear pattern P (see FIG. 4) in advance in which the wear amount of being worn by a single polishing operation is associated with the polishing operation count for the linear grinding members 2 with the reference dimension M (the linear grinding members 2 of the unused polishing brush 3).

Next, the operator connects the shank of the polishing tool holder 4 to the spindle 5a of the machine tool 5 (step ST2). Thereafter, the machine tool 5 disposes a first workpiece W in a predetermined processing position (step ST3). The machine tool 5 then starts the polishing operation for the first workpiece W(1) (step ST4).

In the polishing operation, the machine tool 5 brings the polishing device 1 closer to the workpiece W(1) while rotating the polishing device 1, so that the distance between the spindle 5a of the machine tool 5 and the surface S to be polished of the workpiece W(1) is the setting distance D. The setting distance D is the distance at which the linear grinding members 2 of the polishing brush 3 held in the polishing tool holder 4 connected to the spindle 5a are in contact with the surface S to be polished of the workpiece W(1) at a predetermined depth of cut E. The machine tool 5 polishes the workpiece W(1) for a predetermined duration while moving the polishing device 1 along a predetermined polishing path along the surface S to be polished while maintaining the distance between the polishing tool holder 4 and the surface S to be polished at the setting distance D.

Here, at step ST4, the polishing device control unit 106 detects the rotation state of the polishing device 1 based on an output from the rotation detector 53. As illustrated in FIG. 14, when the rotation state of the polishing device 1 is detected, the polishing device control unit 106 calculates a new polishing operation count by adding 1 to the polishing operation count stored and retained in the storage unit 52, and updates the polishing operation count in the storage unit 52 with the calculated polishing operation count (step ST41). When the polishing operation count is calculated, the polishing device control unit 106 acquires the wear amount by referring to the wear pattern P in the storage unit 52 based on the calculated polishing operation count (step ST42). Further, when the wear amount is acquired, the polishing device control unit 106 calculates the grinding member length dimension by subtracting the wear amount from the reference dimension M, and stores and retains the calculated grinding member length dimension into the storage unit 52 (step ST43).

Thereafter, as illustrated in FIG. 6, when the polishing operation for the workpiece W(1) is finished, the machine tool 5 moves the polishing device 1 away from the workpiece W(1) and stops the rotation of the polishing device 1 (step ST5). The machine tool 5 disposes a next workpiece W in the processing position in place of the first workpiece W(1) (step ST6).

Here, at step ST5, the polishing device control unit 106 detects that the rotation state of the polishing device 1 is terminated based on an output from the rotation detector 53. As illustrated in FIG. 14, when the termination of the rotation state of the polishing device 1 is detected, the polishing device control unit 106 issues and transmits a drive command to the polishing device 1. The drive command is a command to drive the motor 35 of the polishing tool holder 4 to move the polishing brush 3 in the first direction X1 by a distance corresponding to the wear amount of the linear grinding members 2 worn by the polishing operation for the first workpiece W (step ST44). The polishing device control unit 106 also determines whether the polishing brush 3 needs to be replaced, based on the grinding member length dimension and the reference dimension M stored and retained in the storage unit 52 (step ST45). Since steps ST1 to ST5 are the polishing operation for the first workpiece W1, the linear grinding members 2 of the polishing brush 3 are sufficiently long at a point in time of step ST45. Thus, at step ST25, it is determined that the polishing brush 3 does not need to be replaced.

Here, the polishing device 1 receiving the drive command performs the grinding member protruding operation (step ST46). In the grinding member protruding operation, the polishing device control unit 106 drives the motor 35 to move the polishing brush 3 in the first direction X1 by a distance corresponding to the wear amount of the linear grinding members 2 worn by the polishing operation for the first workpiece W. As a result, the polishing device control unit 106 protrudes the linear grinding members 2 in the first direction X1.

Thereafter, as illustrated in FIG. 6, the machine tool 5 starts the polishing operation for the next workpiece W(n) disposed in the processing position (step ST7). In other words, the machine tool 5 brings the polishing device 1 closer to the workpiece W(n) while rotating the polishing device 1, so that the distance between the spindle 5a and the workpiece W(n) is the setting distance D. As a result, the linear grinding members 2 of the polishing brush 3 are in contact with the surface S to be polished of the workpiece W(n) at a predetermined depth of cut E. The machine tool 5 performs polishing for a predetermined duration while moving the polishing device 1 along a predetermined polishing path along the surface S to be polished while maintaining the distance between the polishing device control unit 106 and the surface S to be polished at the setting distance D.

At step ST7, the polishing device control unit 106 detects the rotation state of the polishing device 1 based on an output from the rotation detector 53. As illustrated in FIG. 14, when the rotation state of the polishing device 1 is detected, the polishing device control unit 106 calculates a new polishing operation count by adding 1 to the polishing operation count stored and retained in the storage unit 52, and updates the polishing operation count in the storage unit 52 (step ST51). When the polishing operation count is calculated, the polishing device control unit 106 acquires the wear amount by referring to the wear pattern P based on the calculated polishing operation count (step ST52). Further, when the wear amount is acquired, the polishing device control unit 106 calculates a new grinding member length dimension by subtracting the wear amount from the grinding member length dimension stored in the storage unit 52, and updates the grinding member length dimension in the storage unit 52 (step ST53).

Thereafter, when the polishing operation for the workpiece W(n) is finished, as illustrated in FIG. 6, the machine tool 5 moves the polishing device 1 away from the workpiece W(n) and stops the rotation of the polishing device 1 (step ST8).

Here, the machine tool 5 determines whether there is a workpiece to be polished (step ST9). If there is a workpiece to be polished (step ST9: Yes), the machine tool 5 disposes a next workpiece W in the processing position in place of the workpiece W(n) (step ST10). If there is no workpiece to be polished (step ST9: No), the polishing process ends.

At step ST8, the polishing device control unit 106 detects that the rotation state of the polishing device 1 is terminated based on an output from the rotation detector 53. As illustrated in FIG. 14, when the termination of the rotation state of the polishing device 1 is detected, the polishing device control unit 106 issues and transmits a drive command to the polishing device 1. The drive command is a command to drive the motor 35 of the polishing tool holder 4 to move the polishing brush 3 in the first direction X1 by a distance corresponding to the wear amount of the linear grinding members 2 worn by the polishing operation for the first workpiece W (step ST54). The polishing device control unit 106 also determines whether the polishing brush 3 needs to be replaced, based on the grinding member length dimension and the reference dimension M stored and retained in the storage unit 52 (step ST55). If it is determined that the polishing brush 3 needs to be replaced (step ST55: Yes), the polishing device control unit 106 issues and transmits a notification command to the polishing device 1 (step ST56).

Here, when receiving the drive command at step ST54, the polishing device 1 performs the grinding member protruding operation (step ST57). In the grinding member protruding operation, the polishing device control unit 106 drives the motor 35 to move the polishing brush 3 in the first direction X1 by a distance corresponding to the wear amount of the linear grinding members 2 worn by the polishing operation for the first workpiece W. As a result, the polishing device control unit 106 protrudes the linear grinding members 2 in the first direction X1. When receiving the notification command at step ST56, the polishing device 1 drives the light emitter 54 to indicate by light that the polishing brush 3 needs to be replaced (step ST58). When the light emitter 54 emits light, the operator stops the machine tool 5 and replaces the polishing brush 3.

Thereafter, as illustrated in FIG. 6, the machine tool 5 performs the polishing operation for the next workpiece W disposed in the processing position (steps ST7 and ST8). In the polishing process, steps ST8 to ST11 are repeated until there is no more workpiece W to be polished (step ST9: No).

If the light emitted by the light emitter 54 indicates that the polishing brush 3 needs to be replaced (step ST58), the operator stops the machine tool 5 and replaces the polishing brush 3 with a new polishing brush 3. After that, the next workpiece W to be polished is set as the first workpiece W, and steps ST7 to ST10 are repeated until there is no more workpiece W to be polished.

### Operation Effects

The polishing system 100 according to the present invention includes the polishing device 1 including the polishing tool holder 4 and the polishing brush 3, and the cloud computer 103 connected to the polishing device 1 (polishing tool holder 4) via the network 102. The polishing device control unit 106 of the cloud computer 103 includes the drive command issuing unit 107 that issues a drive command. The polishing tool holder 4 includes the motor 35 (drive source), the moving mechanism 22 that moves the polishing brush 3 supported on the support mechanism 21, the control unit 51 that drives and controls the motor 35 based on a drive command, and the power supply 59 that supplies power to the motor 35 and the control unit 51. Thus, the polishing system 100 can drive the moving mechanism 22 of the polishing tool holder 4 based on a drive command from the cloud computer 103 and move the polishing brush 3 in the axial direction X. As a result, the polishing device 101 can automatically perform the grinding member protruding operation of protruding the linear grinding members 2 to the opposite side of the shank 6 by moving the polishing brush 3 in the axial direction X.

In this example, the cloud computer 103 that can communicate with the polishing tool holder 4 acquires the wear amount by referring to the wear pattern P stored and retained in the storage unit 52 of the cloud computer 103 every time a single polishing operation is finished in the polishing device 101. Further, when the wear amount is acquired, the cloud computer 103 issues a drive command to perform the grinding member protruding operation that drives the motor 35 of the polishing device 101 and operates the moving mechanism 22 to move the polishing brush 3 to the opposite side of the shank by a distance corresponding to the wear amount, and transmits the drive command to the polishing tool holder 4. When receiving the drive command, the polishing device 101 drives the motor 35 to perform the grinding member protruding operation. Here, the wear pattern P associates the wear amount of being worn by a single polishing operation with the polishing operation count for the linear grinding members 2 with the reference dimension M at a point in time when the polishing brush 3 is supported on the support mechanism 21. Thus, if the wear amount is acquired by referring to the wear pattern P based on the polishing operation count, the acquired wear amount reflects the wear amount of the grinding member that varies with the length dimension of the linear grinding members 2 at the start of the polishing operation. As a result, the protruding amount of the linear grinding members 2 in the grinding member protruding operation can be matched to the wear amount by which the grinding member is worn by polishing of the previous workpiece W. Thus, the polishing system 100 can automatically perform protrusion of the grinding member and prevent or suppress variations in accuracy of polishing for each workpiece in a polishing process of performing the identical polishing operation in succession multiple times while replacing the workpieces.

When the termination of the rotation state is detected based on an output from the rotation detector 53, the drive command issuing unit 107 may issue a drive command next time the rotation detector 53 detects the rotation state. In other words, after the polishing operation for one workpiece W is finished and when the machine tool 5 rotates the polishing brush 3 for the polishing operation for the next workpiece W, the cloud computer 103 may issue and transmit a drive command to cause the polishing device 101 to perform the grinding member protruding operation.

Here, the rotation detector 53 may be a vibration sensor. The rotation detector 53 can be a switch that includes a conductive member movable by centrifugal force, and the conductive member connects or disconnects a circuit.

Also in this example, the polishing tool holder 4 may hold the polishing tool 70 having the elastic grinder 71 as the grinding member. The polishing tool holder 4 may hold the polishing tool 80 having the rigid grinder 81 as the grinding member.

### Other Embodiments

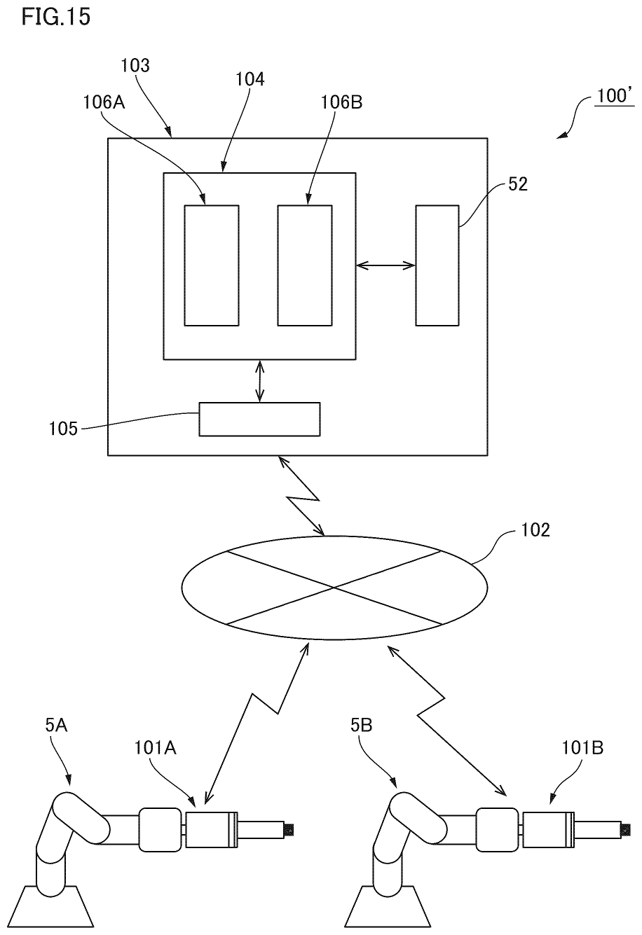

Here, the polishing system 100 may include a plurality of polishing devices 101 communicatively connected to the cloud computer 103. FIG. 15 is an illustration of a polishing system 100′ with a plurality of polishing devices 101. Since the polishing system 100′ illustrated in FIG. 15 has a configuration corresponding to that of the polishing system 100, the corresponding configuration is denoted by the same symbol and will not be further elaborated.

The polishing system 100′ in this example includes, as the polishing device 101, a first polishing device 101A and a second polishing device 101B communicatively connected to the cloud computer 103 via the network 102. The cloud computer 103 includes the cloud computer-side control unit 104, the storage unit 52, and the cloud computer-side communication unit 105. The cloud computer-side control unit 104 includes, as the polishing device control unit 106, a first polishing device control unit 106A and a second polishing device control unit 106B. The first polishing device control unit 106A receives an output from the rotation detector 53 of the first polishing device 101A. The first polishing device control unit 106A issues and transmits a drive command and a notification command to the first polishing device 101A. The second polishing device control unit 106B receives an output from the rotation detector 53 of the second polishing device 101B. The second polishing device control unit 106B issues and transmits a drive command and a notification command to the second polishing device 101B. The first polishing device control unit 106A and the second polishing device control unit 106B each refer to the same wear pattern P stored and retained in the storage unit 52 when acquiring the wear amount.

The cloud computer 103 can identify the first polishing device 101A and the second polishing device 101B by individually assigned identification codes or the like. Alternatively, the cloud computer 103 may identify the first polishing device 101A and the second polishing device 101B by their respective addresses on the network 102.

In this example, a manufacturing line for performing a polishing process includes, as the machine tool 5, a first machine tool 5A and a second machine tool 5B that perform the identical polishing process. The first polishing device 101A is connected to the first machine tool 5A, and the second polishing device 101B is connected to the second machine tool 5b. Using the polishing system 100′ in such a case, these polishing devices 101 can be driven and controlled by one cloud computer 103.

In the polishing system 100′, the grinding member protruding operation for each of a plurality of polishing devices 101 can be performed by acquiring the wear amount of the linear grinding members 2 based on one wear pattern P stored and retained in the storage unit 52 of the cloud computer 103. Further, the wear pattern P of a plurality of polishing devices 101 can be changed collectively by updating the wear pattern P in the storage unit 52.

According to this example, the wear state of the grinding members of a plurality of polishing devices 101 can be grasped on the cloud computer 103 side. Thus, a plurality of polishing devices 101 connected to the respective machine tools can be centrally controlled. Further, the cloud computer 103 gathers outputs from the rotation detectors of a plurality of polishing devices 101. Thus, on the cloud computer 103 side, the operating state of each machine tool 5 can be grasped based on the rotation state of each polishing device 101.

When the first machine tool 5A and the second machine tool 5B perform different polishing processes, the first polishing device 101A and the second polishing device 101B may have different polishing tools. In this case, a first wear pattern and a second wear pattern are stored and retained in the storage unit 52 of the cloud computer 103. The first polishing device control unit 106A transmitting a drive command to the first polishing device 101A can acquire the wear amount by referring to the first wear pattern, and the second polishing device control unit 106B transmitting a drive command to the second polishing device 101B can acquire the wear amount by referring to the second wear pattern.

1. A polishing tool holder comprising a shank connectable to a spindle of a machine tool, a support mechanism configured to support a polishing tool including a grinding member holder and a grinding member held in the grinding member holder such that the polishing tool is movable in an axial direction of the shank, a drive source, and a moving mechanism configured to move the polishing tool in the axial direction,
the polishing tool holder comprising a control unit configured to drive and control the drive source, a storage unit connected to the control unit, a rotation detector configured to detect a rotation state of being rotated by the machine tool, and a power supply configured to supply power to the drive source and the control unit, wherein
the storage unit stores and retains a reference dimension, a polishing operation count, and a wear pattern, the reference dimension being a dimension of the grinding member at a point in time when the polishing tool is supported on the support mechanism, the polishing operation count being a number of times the rotation detector detects the rotation state, the wear pattern associating a wear amount by which the grinding member with the reference dimension is worn by a single polishing operation of polishing a workpiece with the polishing operation count, and
the control unit includes: a polishing operation count updating unit configured to, when the rotation detector detects the rotation state, calculate a new polishing operation count by adding 1 to the polishing operation count and update the polishing operation count in the storage unit; a wear amount acquiring unit configured to, when the polishing operation count is calculated, acquire the wear amount by referring to the wear pattern based on the polishing operation count; and a drive control unit configured to, when termination of the rotation state is detected based on an output from the rotation detector, perform a grinding member protruding operation that drives the drive source and operates the moving mechanism to move the polishing tool to an opposite side of the shank by a distance corresponding to the wear amount.

2. The polishing tool holder according to claim 1, wherein the drive control unit performs the grinding member protruding operation when termination of the rotation state is detected.

3. The polishing tool holder according to claim 1, wherein when termination of the rotation state is detected, the drive control unit performs the grinding member protruding operation next time the rotation detector detects the rotation state.

4. The polishing tool holder according to claim 1, further comprising a notifying unit, wherein
the control unit includes: a grinding member length dimension calculating unit configured to, when the wear amount is acquired for the first time, calculate a grinding member length dimension by subtracting the wear amount from the reference dimension and store and retain the calculated grinding member length dimension into the storage unit, and thereafter every time the wear amount is acquired, calculate a new grinding member length dimension by subtracting the wear amount from the grinding member length dimension and update the grinding member length dimension in the storage unit; a replacement determining unit configured to, every time the grinding member length dimension is calculated, determine whether the polishing tool needs to be replaced based on the grinding member length dimension and the reference dimension; and a replacement notifying unit configured to, when the replacement determining unit determines that the polishing tool needs to be replaced, drive the notifying unit to indicate that the polishing tool needs to be replaced.

5. The polishing tool holder according to claim 1, further comprising a communication unit configured to perform communication with an external device, wherein
the reference dimension and the wear pattern are input to the control unit via the communication unit and stored and retained in the storage unit.

6. The polishing tool holder according to claim 1, wherein the rotation detector is an accelerometer.

7. The polishing tool holder according to claim 1, wherein the rotation detector is a vibration sensor.

8. The polishing tool holder according to claim 1, wherein the rotation detector is a switch that includes a conductive member movable by centrifugal force, and the conductive member connects or disconnects a circuit.

9. The polishing tool holder according to claim 1, wherein
the support mechanism includes a connecting member having a through hole passing through in the axial direction, and a shaft member passing through the through hole coaxially with the shank and extending in the axial direction,
the drive source is a motor,
the moving mechanism includes a rotational support mechanism configured to support the shaft member such that the shaft member is rotatable about an axis of the shank, a female thread on an inner peripheral surface of the through hole, a male screw on an outer peripheral surface of the shaft member, the male screw being screwed to the female thread, a drive force transmitting mechanism configured to transmit rotation of the motor to the shaft member, a sleeve configured to guide the connecting member in the axial direction on an outer peripheral side of the connecting member and the shaft member, and a rotation regulating mechanism configured to regulate co-rotation of the connecting member and the shaft member,
the polishing tool has the grinding member holder connected to the connecting part, the grinding member partially protruding outward from the sleeve, and
the control unit drives the motor to rotate the shaft member to move the connecting member in the axial direction.

10. A polishing device comprising:
the polishing tool holder according to claim 1; and
a polishing tool including a grinding member holder and a grinding member held in the grinding member holder, wherein
the grinding member includes a plurality of linear grinding members arranged in parallel with a length direction aligned with the axial direction,
the grinding member holder holds one end in the axial direction of each of the linear grinding members, and
the polishing tool is supported by the polishing tool holder to polish a workpiece by bringing another end of each of the linear grinding members into contact with the workpiece.

11. A polishing device comprising:
the polishing tool holder according to claim 1; and
a polishing tool including a grinding member holder and a grinding member held in the grinding member holder, wherein
the grinding member is an elastic grinder,
the grinding member holder holds one end in the axial direction of the elastic grinder, and
the polishing tool is supported by the polishing tool holder to polish a workpiece by bringing another end of the elastic grinder into contact with the workpiece.

12. A polishing device comprising:
the polishing tool holder according to claim 1; and
a polishing tool including a grinding member holder and a grinding member held in the grinding member holder, wherein
the grinding member is a rigid grinder,
the grinding member holder holds one end in the axial direction of the grinder, and
the polishing tool is supported by the polishing tool holder to polish a workpiece by bringing another end of the grinder into contact with the workpiece.

13. A polishing system comprising: a polishing device comprising a polishing tool including a grinding member holder and a grinding member held in the grinding member holder, and a polishing tool holder including a shank connectable to a spindle of a machine tool, a support mechanism configured to support the polishing tool such that the polishing tool is movable in an axial direction of the shank, a drive source, and a moving mechanism configured to move the polishing tool in the axial direction; and a cloud computer communicatively connected to the polishing tool holder via a network, wherein
the polishing tool holder includes a control unit configured to drive and control the drive source based on a drive command, a rotation detector configured to detect a rotation state of being rotated by the machine tool, a power supply configured to supply power to the drive source and the control unit, and a communication unit configured to perform communication with the cloud computer,
the communication unit transmits an output from the rotation detector to the cloud computer, receives the drive command from the cloud computer, and inputs the drive command to the control unit,
the cloud computer includes a storage unit and a polishing device control unit, the storage unit being configured to store and retain a reference dimension, a polishing operation count, and a wear pattern, the reference dimension being a dimension of the grinding member at a point in time when the polishing tool is supported on the support mechanism, the polishing operation count being a number of times the rotation detector detects the rotation state, the wear pattern associating a wear amount by which the grinding member with the reference dimension is worn by a single polishing operation of polishing a workpiece with the polishing operation count, and
the polishing device control unit includes: a polishing operation count updating unit configured to, when the rotation detector detects the rotation state, calculate a new polishing operation count by adding 1 to the polishing operation count and update the polishing operation count in the storage unit; a wear amount acquiring unit configured to, when the polishing operation count is calculated, acquire the wear amount by referring to the wear pattern based on the polishing operation count; a drive command issuing unit configured to, when termination of the rotation state is detected based on an output from the rotation detector, issue the drive command to perform a grinding member protruding operation that drives the drive source and operates the moving mechanism to move the polishing tool to an opposite side of the shank by a distance corresponding to the wear amount; and a command transmitting unit configured to, when the drive command is issued, transmit the drive command to the polishing tool holder.

14. The polishing system according to claim 13, wherein the drive command issuing unit issues the drive command when termination of the rotation state is detected.

15. The polishing system according to claim 13, wherein when termination of the rotation state is detected, the drive command issuing unit issues the drive command next time the rotation detector detects the rotation state.

16. The polishing system according to claim 13, wherein
the polishing tool holder comprises a notifying unit,
the polishing device control unit includes: a grinding member length dimension calculating unit configured to, when the wear amount is acquired for the first time, calculate a grinding member length dimension by subtracting the wear amount from the reference dimension and store and retain the calculated grinding member length dimension into the storage unit, and thereafter every time the wear amount is acquired, calculate a new grinding member length dimension by subtracting the wear amount from the grinding member length dimension and update the grinding member length dimension in the storage unit; a replacement determining unit configured to, every time the grinding member length dimension is calculated, determine whether the polishing tool needs to be replaced based on the grinding member length dimension and the reference dimension; and a notification command issuing unit configured to, when the replacement determining unit determines that the polishing tool needs to be replaced, drive the notifying unit to issue a notification command to indicate that the polishing tool needs to be replaced, and
when the notification command is issued, the command transmitting unit transmits the notification command to the polishing tool holder.

17. The polishing system according to claim 13, wherein
the support mechanism includes a connecting member having a through hole passing through in the axial direction, and a shaft member passing through the through hole coaxially with the shank and extending in the axial direction,
the drive source is a motor,
the moving mechanism includes a rotational support mechanism configured to support the shaft member such that the shaft member is rotatable about an axis of the shank, a female thread on an inner peripheral surface of the through hole, a male screw on an outer peripheral surface of the shaft member, the male screw being screwed to the female thread, a drive force transmitting mechanism configured to transmit rotation of the motor to the shaft member, a sleeve configured to guide the connecting member in the axial direction on an outer peripheral side of the connecting member and the shaft member, and a rotation regulating mechanism configured to regulate co-rotation of the connecting member and the shaft member,
the polishing tool has the grinding member holder connected to the connecting part, the grinding member partially protruding outward from the sleeve, and
the control unit drives the motor to rotate the shaft member to move the connecting member in the axial direction.

18. The polishing system according to claim 13, comprising, as the polishing device, a first polishing device and a second polishing device communicatively connected to the cloud computer via a network, wherein
the cloud computer includes, as the polishing device control unit, a first polishing device control unit configured to receive an output from the rotation detector of the first polishing device and transmit the drive command to the first polishing device, and the polishing device control unit configured to receive an output from the rotation detector of the second polishing device and transmit the drive command to the second polishing device.
